(19) United States
(12) Patent Application Publication
(10) Pub. No.: US 2025/0084699 A1
(43) Pub. Date: Mar. 13, 2025

(54) LADDERS, LADDER ACCESSORIES, COMPONENTS THEREOF, AND LOCK ASSEMBLIES FOR USE THEREWITH

(71) Applicant: Werner Co., Greenville, PA (US)

(72) Inventors: Fang Chen, Tennyson, Queensland (AU); Vlatko Papa, Park Ridge, IL (US); Derek Bibler, Charlotte, NC (US); Carl William Behm, Berrinba, Queensland (AU); Ben Phillip Loveday, Berrinba, Queensland (AU)

(21) Appl. No.: 18/729,038

(22) PCT Filed: Jan. 31, 2023
(86) PCT No.: PCT/US2023/012018

§ 371 Date: Jul. 15, 2024

Related U.S. Application Data
(60) Provisional application No. 63/305,210, filed on Jan. 31, 2022.

(51) Int. Cl. E06C 7/06; E06C 1/22; E06C 7/50

(52) U.S. Cl. CPC E06C 7/06; E06C 1/22; E06C 7/50

(57) ABSTRACT

Lock assemblies for ladders and other rail assemblies are provided. In some embodiments, a ladder section includes a first rail and a second rail with openings extending therethrough. A lock assembly is disposed between the first rail and the second rail to selectively engage the opening in the first and second rails. The lock assembly includes a first rod and a second rod. The lock assembly also includes a first pusher that engages the first rod and a second pusher that engages the second rod. A first lever extends from an outer surface of the first pusher. A second lever extends from an outer surface of the second pusher to create a pinch grasp portion with the first lever. The lock assembly has a locked position that secures the ladder section and an unlocked position that allows the ladder section to be reconfigured with respect to another structure.

### CROSS-REFERENCE TO RELATED APPLICATION(S)

This application claims the benefit of U.S. Provisional Application No. 63/305,210 filed Jan. 31, 2022, which is incorporated herein by reference in its entirety.

### TECHNICAL FIELD

This invention relates generally to multi-position railed structures and, more specifically, to lock assemblies for multi-position railed structures.

### BACKGROUND

Multi-position ladders are ladders that may be placed in multiple configurations to suit a variety of jobs and use cases. A multi-position ladder, for example, may include multiple sections that may be placed in different configurations with respect to each other depending on the use case. A multi-position ladder may incorporate one or more locks so that a user may adjust and/or reconfigure the ladder and then resecure the ladder in a desired position. The adjustment of multi-position ladders, however, may be complicated and, at times, involve two-hands to reconfigure the ladder.

### BRIEF DESCRIPTION OF THE DRAWINGS

Disclosed herein are embodiments of systems, apparatuses and methods pertaining to lock assemblies for multi-position ladders. This description includes drawings, wherein:

FIG. 1 is a perspective view of a multi-position ladder that includes a lock assembly, in accordance with some embodiments.

FIG. 2 is an enlarged view of a portion of FIG. 1 illustrating the lock assembly.

FIG. 3 is a top perspective view of a lock assembly for a ladder, component and/or accessory, in accordance with some embodiments.

FIG. 4 is a bottom perspective view of the lock assembly of FIG. 3, depicting the lock assembly in a locked configuration.

FIG. 5 is a top plan view of the lock assembly of FIG. 3, depicting the lock assembly in a locked configuration.

FIG. 6 is a right-side elevation view of the lock assembly of FIG. 3, depicting the lock assembly in a locked configuration.

FIG. 7 is a top plan view of the lock assembly of FIG. 3, depicting the lock assembly in an unlocked configuration.

FIG. 8 is a right-side elevation view of the lock assembly of FIG. 3, depicting the lock assembly in an unlocked configuration.

FIG. 9 is a top perspective view of the lock assembly of FIG. 3 having the housing removed, depicting the lock assembly in a locked configuration.

FIG. 10 is a top perspective view of internal portions of the lock assembly of FIG. 3, depicting the lock assembly in an unlocked configuration.

FIG. 11 is a right-side elevation view of a j-lock component of the lock assembly of FIG. 3.

FIG. 12 is a perspective view of a j-lock component of the lock assembly of FIG. 3.

FIG. 13 is bottom plan view of a j-lock component of the lock assembly of FIG. 3.

FIG. 14 is a perspective view of a multi-position ladder including a lock assembly depicting the ladder in a folded position, in accordance with some embodiments.

FIG. 15 is a perspective view of the multi-position ladder of FIG. 14, depicting the ladder in a folded position with the ladder sections extended.

FIG. 16 is a perspective view of the multi-position ladder of FIG. 14, depicting the ladder in a step ladder configuration.

FIG. 17 is a perspective view of the multi-position ladder of FIG. 14, depicting the ladder in a step ladder configuration with the ladder sections extended.

FIG. 18 is a perspective view of the multi-position ladder of FIG. 14, depicting the ladder in an extension ladder configuration.

FIG. 19 is a cross-sectional view of a lock assembly of the multi-position ladder of FIG. 14, depicting the lock assembly in a locked configuration.

FIG. 20 is a cross-sectional view of another lock assembly depicting the lock assembly in a locked configuration.

FIG. 21 is an exploded view of another lock assembly depicting the lock assembly in a locked configuration.

FIG. 22 is a perspective view of a lock assembly, in accordance with some embodiments.

FIG. 23 is an exploded view of the lock assembly of FIG. 22.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

A ladder, a ladder accessory, and components thereof, such as multi-position ladder may include one or more locks to secure a ladder or components thereof in different positions. In one illustrative approach, actuating the locks allows a user to switch between different positions or configurations. The locks may engage the rails on each side of the ladder. In one example, an interface between a first section and a second section of a ladder may include locks on each side of the rails. In this arrangement, actuating locks on each side of the rails may allow a user to adjust a height of the ladder. In another example, a hinge portion positioned at the top of a ladder may include locks on each side of the ladder. In this arrangement, actuating the locks on each side of the ladder may allow a user to fold or unfold the ladder. Previously, locking and/or unlocking the locks generally involve separate operations generally to engage or disengage the locks from the rails on each side of the ladder. Accordingly, an adjustment or reconfiguration of the ladder may be a two-handed and multi-stepped operation. Further, separate actuation of the locks on each side of the rail complicates operation of the ladder and makes reconfiguration less efficient. Thus, it may not be possible for a user to adjust the ladder with one free hand or while standing on a rung of the ladder.

Generally speaking, the lock assemblies are provided herein that may be used with a ladder or other railed structure to facilitate easier, one-handed adjustment or reconfiguration of the ladder. In some approaches, one or more of the lock assemblies described herein may be incorporated into a ladder to achieve one-handed adjustment or reconfiguration. The lock assemblies described herein include a pinch grasp portion to facilitate one-handed operation. The pinch grasp portion enables one-handed unlocking and locking of rail locks on both sides of a ladder. The lock assemblies described herein may be employed in ladders, ladder accessories, components thereof, or other railed structures to facilitate adjustment or reconfiguration of a ladder. In some approaches, the lock assemblies may be incorporated into a ladder at an interface between two different sections so that a user may adjust one section relative to another section. In other approaches, the lock assemblies may be incorporated into a ladder at a top hinge that joins two rail assemblies so that a user may adjust an angle between the rail assemblies. In yet other approaches, the lock assemblies described herein may be used to attach one or more accessories to a ladder, for example by selectively engaging openings in the rails.

The lock assemblies described herein may be integrated into any railed structure. A railed structure may include, for example, a rail assembly having two or more vertical components (e.g., rails, tubes, etc.) joined together by at least one horizontal component (e.g., tubes, rungs, etc.). In some non-limiting configurations, the vertical components may have a box, channel, or C-shaped profile. The railed structures include, but are not limited to, ladders, scaffolds, and work platforms.

In some aspects, a rail assembly in accordance with these teachings includes a first rail and a second rail opposite the first rail. The first rail includes a first opening extending therethrough. The second rail includes a second opening extending therethrough. A lock assembly is disposed between the first rail and the second rail to selectively engage the first opening and the second opening. In one embodiment, the lock assembly includes a first rod having a proximal portion adjacent to the first rail and a distal end portion opposite the proximal end portion. The lock assembly further typically includes a second rod having a proximal end portion adjacent to the second rail and a distal end portion opposite the proximal end portion. The lock assembly also has a first pusher having a first flange portion that engages the first rod and a first leg portion that extends from the first flange portion opposite the first rod. A first lever extends from an outer surface of the first pusher. The lock assembly also includes a second pusher having a second flange portion that engages the second rod and a second leg portion that extends from the second flange portion opposite the second rod. A second lever extends from an outer surface of the second pusher to create a pinch grasp portion with the first lever. The lock assembly has a locked position that secures the ladder section and an unlocked position that allows the ladder section to be reconfigured with respect to another structure. In the locked position, the proximal end portion of the first rod engages the first opening and the proximal end portion of the second rod engages the second opening. In the unlocked position, the proximal end portion of the first rod disengages the first opening and the proximal end portion of the second rod disengages the second opening.

In some aspects, a rail assembly in accordance with these teachings includes a first rail and a second rail opposite the first rail. The first rail includes a first opening extending therethrough. The second rail includes a second opening extending therethrough. A lock assembly is disposed between the first rail and the second rail to selectively engage the first opening and the second opening. The lock assembly includes a first rod having a proximal portion adjacent to the first rail and a distal end portion opposite the proximal end portion. The distal end portion of the first rod is coupled to a first lever. The lock assembly further includes a second rod having a proximal end portion adjacent to the second rail and a distal end portion opposite the proximal end portion. The distal end portion of the second rod is coupled to a second lever. The second lever creates a pinch grasp portion with the first lever. The lock assembly has a locked position that secures the ladder section and an unlocked position that allows the ladder section to be reconfigured with respect to another structure. In the locked position, the proximal end portion of the first rod engages the first opening and the proximal end portion of the second rod engages the second opening. In the unlocked position, the proximal end portion of the first rod disengages the first opening and the proximal end portion of the second rod disengages the second opening.

In some aspects, a ladder in accordance with these teachings includes a first section including a first left rail and a first right rail opposite the first left rail. The ladder further includes a second section including a second left rail and a second right rail opposite the second left rail. The second section has a lock assembly disposed between the second left rail and the second right rail. The lock assembly includes a right rod having a proximal portion adjacent to the second right rail and a distal end portion opposite the proximal end portion. The distal end portion of the right rod is coupled to a left lever. The lock assembly further includes a left rod having a proximal end portion adjacent to the second left rail and a distal end portion opposite the proximal end portion. The distal end portion of the left rod is coupled to a right lever. The right lever creates a pinch grasp portion with the left lever. The lock assembly has a locked position and an unlocked position for reconfiguring the first section relative to the second section. In the locked position, the proximal end portion of the right rod engages the first right rail and the second right rail and the proximal end portion of the left rod engages first left rail and the second left rail. In the unlocked position, the proximal end portion of the right rod disengages the first right rail and the second right rail and the proximal end portion of the left rod disengages the first left rail and the second left rail. When the lock assembly is in the unlocked position, the first section is free to move relative to the second section so that the ladder may be reconfigured.

In some aspects, a ladder in accordance with these teachings includes a first section including a first left rail and a first right rail opposite the first left rail; and a second section including a second left rail and a second right rail opposite the second left rail. The second section has a lock assembly disposed between the second left rail and the second right rail. The lock assembly includes a right rod having a proximal portion adjacent to the second right rail and a distal end portion opposite the proximal end portion. The distal end portion of the right rod is coupled to a right lever. The lock assembly further includes a left rod having a proximal end portion adjacent to the second left rail and a distal end portion opposite the proximal end portion. The distal end portion of the left rod is coupled to a left lever. The right lever creates a pinch grasp portion with the left lever. The lock assembly has a locked position and an unlocked position for reconfiguring the first section relative to the second section. In the locked position, the proximal end portion of the right rod engages the first right rail and the second right rail and the proximal end portion of the left rod engages first left rail and the second left rail. In the unlocked position, the proximal end portion of the right rod disengages the first right rail and the second right rail and the proximal end portion of the left rod disengages the first left rail and the second left rail. When the lock assembly is in the unlocked position, the first section is free to move relative to the second section so that the ladder may be reconfigured.

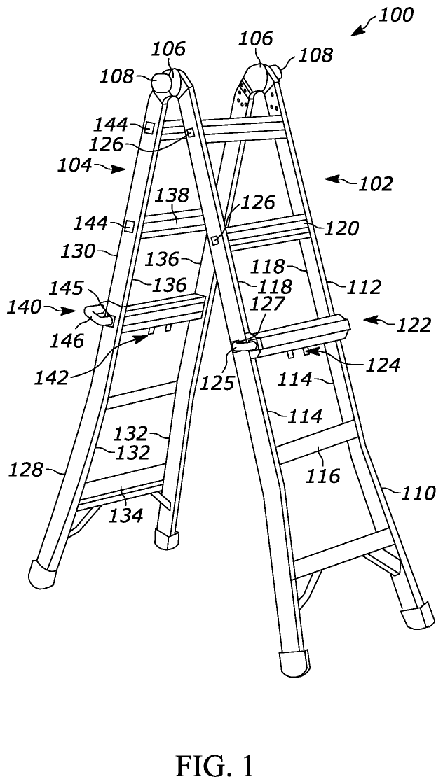

Referring now to the drawings and, in particular, to FIG. 1, a ladder 100 that includes a first embodiment of a lock assembly is shown. Two lock assemblies are installed in the ladder 100: a first lock assembly 122 on one side; and a second lock assembly 140 on another side. The lock assemblies may be employed to reconfigure or adjust the ladder 100.

The ladder 100 is a multi-position ladder that has a number of different configurations. In FIG. 1, the ladder 100 is shown in a step ladder configuration and, in particular, a double-sided step ladder. The ladder 100 may also be positioned, for example, in a wall ladder configuration, an extension ladder configuration, a work platform configuration (e.g., configured as two self-supported bases), or a stairway ladder configuration.

The ladder 100 includes a first rail assembly 102 and a second rail assembly 104 opposite the first rail assembly 102. A first and a second hinge assembly 106 rotatably couples the first rail assembly 102 to the second rail assembly 104. Each hinge assembly 106 includes a pin that permits the first rail assembly 102 and the second rail assembly 104 to pivot relative to each other. Each hinge assembly 106 also typically includes a hinge lock having one or more pins that engage a top portion of the first rail assembly and a top portion of the second rail assembly to lock the first rail assembly 102 at an angle relative to the second rail assembly 104. In some configurations, a push knob 108 is coupled to each hinge assembly 106 for operating the hinge lock. Pushing on the push knobs 108 disengages the hinge locks from the first rail assembly 102 and the second rail assembly 104. The ladder 100 may include any suitable hinge and hinge lock to rotate and lock the first rail assembly 102 and the second rail assembly 104 relative to each other. When unlocked, the first rail assembly 102 and the second rail assembly 104 are free to rotate about the hinge assembly 106 to adjust an angle between the first rail assembly 102 and the second rail assembly 104. In this manner, the ladder 100 can be folded, or unfolded into a step ladder configuration or, in some aspects, unfolded into an extension ladder configuration.

The first rail assembly 102 includes a first section 110 and a second section 112. The first section 110 is the lower of the two adjacent sections, from which the second section 112 is extended upward. The first section 110 includes a pair of outer rails 114 having a plurality of rungs 116 disposed therebetween. The second section 112 includes a pair of inner rails 118 having a plurality of rungs 120 disposed therebetween. In some configurations, the outer rails 114 of the first section 110 telescopingly engage the inner rails 118 of the second section 112. The outer rails 114 slidingly engage the inner rails 118 such that the second section 112 can be adjusted to different heights.

The first rail assembly 102 further includes a first lock assembly 122 that selectively engages the inner rails 118 and the outer rails 114. The first lock assembly 122 is integrated into one of the plurality of rungs 116 of the first section 110. While the first lock assembly 122 is integrated into the topmost of the rungs 116 in FIG. 1, it is contemplated that, in other approaches, the first lock assembly 122 could be integrated into any one of the rungs 116 in the first section 110. The first lock assembly 122 includes a pair of rail locks 125 coupled to the outer rails 114. The rail locks 125 are received by openings in the outer rails 114 and the inner rails 118. The first lock assembly 122 also includes a pinch grasp portion 124 that is coupled to the rail locks 125. In other approaches, the first lock assembly 122 may be integrated into one of the rungs 120 in the second section 112, for example, in the bottommost of the rungs 127.

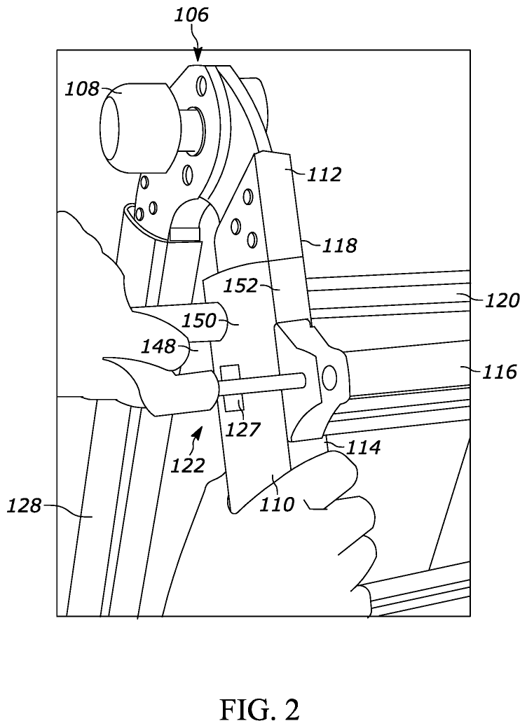

The pinch grasp portion 124 operates the first lock assembly 122 to selectively engage the rail locks 125 with the inner rails 118 and/or the outer rails 114. The inner rails 118 of the second section 112 include pairs of openings 126 that are disposed on each side of the rungs 120. Further, the outer rails 114 include a pair of openings 127 (also shown in FIG. 2) that are disposed on each side of the rung 116 that includes the first lock assembly 122. Operating the pinch grasp portion 124 actuates the rail locks 125 to move the rail locks 125 between a locked position and an unlocked position. In the locked position, the rail locks 125 engage one of the pairs of openings 126 (not visible in FIG. 1) in the inner rails 118 of the second section 112 and also engage the pair of openings 127 in the first section 110. In the unlocked position, the rail locks 125 disengage the pairs of openings 126 in the inner rails 118 of the second section 112 and also disengage the pair of openings 127 in the first section 110.

The second rail assembly 104 also includes a first section 128 and a second section 130. The first section 128 includes a pair of outer rails 132 having a plurality of rungs 134 disposed therebetween. The second section 130 includes a pair of inner rails 136 having a plurality of rungs 138 disposed therebetween. The outer rails 132 of the first section 128 telescopingly engage the inner rails 136 of the second section 130. The outer rails 132 slidingly engage the inner rails 136 such that the second section 130 can be adjusted to different heights.

The second rail assembly 104 further includes a second lock assembly 140 that selectively engages the inner rails 136 and/or the outer rails 132. As shown in this embodiment, the second lock assembly 140 is built into one of the plurality of rungs 134 in the first section 128. While the second lock assembly 140 is integrated into the topmost of the rungs 134 in FIG. 1, it is contemplated that, in other approaches, the second lock assembly 140 could be integrated into any one of the rungs 134. The second lock assembly 140 includes a pair of rail locks 146 coupled to the outer rails 132. The second lock assembly also includes a pinch grasp portion 142 coupled to the pair of rail locks 146. In other approaches, the second lock assembly 140 may be integrated into one of the rungs 138 in the second section 130, for example, in the bottommost of the rungs 138, or even in other ladder components.

The pinch grasp portion 142 operates the second lock assembly 140 to selectively engage the rail locks 146 with the inner rails 136 and/or the outer rails 132. The inner rails 136 of the second section 130 include openings 144 disposed on each side of the rungs 138. Further, the outer rails 132 include a pair of openings 145 that are disposed on each side of the rung 134 that includes the second lock assembly 140. Operating the pinch grasp portion 142 actuates the rail locks 146 to move the rail locks 146 between a locked position and an unlocked position. In the locked position, the rail locks 146 engage a pair of openings 144 in the inner rails 136 (not visible in FIG. 1) of the second section 130 and also engage the pair of openings 145 in the first section 128 when the openings 144, 145 are aligned. In the unlocked position, the rail locks 146 disengage a pair of openings 144 in the inner rails 136 of the second section 130 and also disengage the pair of openings 145 in the first section 128.

In some aspects, the rail locks 125, 146 are j-locks. However, it is contemplated that the lock assemblies 122, 140 may employ any suitable type of lock, such as a pin or rod-based lock, to engage the rails 114, 118, 132, 136 of the ladder 100.

In some aspects, the rails 114, 118, 132, 136, the rungs 116, 120, 134, 138 and other structural components of the ladder 100 may be made of a metal material such as aluminum or an aluminum alloy. In other aspects, the rails 114, 118, 132, 136 of the ladder 100 may be made of fiberglass while the rungs 116, 120, 134, 138 are made of a metal material such as aluminum or an aluminum alloy.

In operation, a user may adjust a height of the first rail assembly 102 by operating the pinch grasp portion 124 of the first lock assembly 122. Pinching the pinch grasp portion 124 moves the first lock assembly 122 from the locked position to the unlocked position. In the unlocked position, the inner rails 118 of second section 112 are free to telescope into or out of the outer rails 114 of the first section 110. Thus, when the lock assembly is in the unlocked position the second section 112 is free to travel or be repositioned relative to the first section 110. In this manner, the user may reposition the second section 112 to a desired height by directing the first lock assembly 122 to engage a particular pair of openings 126 in the second section 112. Releasing the pinch grasp portion 124 moves the first lock assembly 122 back to the locked position and secures the second section 112 with respect to the first section 110.

Similarly, a user may adjust a height of the second rail assembly 104 by operating the pinch grasp portion 142 of the second lock assembly 140. Operation of the second lock assembly 140 of the second rail assembly 104 mirrors the operation described above with respect to the first lock assembly 122 of the first rail assembly 102.

It is contemplated that lock assemblies, such as the first lock assembly 122 and the second lock assembly 140, which are operated by pinch grasp portion, may simplify the reconfiguration and adjustment of a ladder or other railed structure. Rather than performing two separate operations to disengage a rail lock, such as a j-lock, from each rail, a user may operate a pinch grasp portion with one hand to operate the rail locks on both rails. In some configurations, the lock assembly 112 may operate rail locks on one or more sides of a ladder. For example, with the lock assemblies 122, 140 installed as show in FIG. 1, a user of the ladder 100 may adjust a height of the second section 112 or the second section 130 while standing on a rung of the ladder.

It is also contemplated that, in some configurations, the lock assembly 122 may also be installed in the top cap of a ladder and may operate hinge locks. For example, the lock assembly 122 may be installed at the top of the ladder 100 and replace the push knobs 108 so that a user may operate hinge locks via a pinch grasp portion. In other configurations, the lock assembly may also be installed or configured to cooperate with any pair of openings in the rails of ladder or other railed structure to add an accessory to the ladder. For example, an accessory piece may be coupled to the lock assembly 122 and, in this manner, the accessory piece may be installed between the inner rails 112 or the outer rails 114 by coupling the accessory piece to the rails using the lock assembly 122.

FIG. 2 illustrates a portion of the ladder 100 of FIG. 1 in a collapsed position. In the collapsed position, the inner rails 118 are nested or received within the outer rails 114 and a top portion of the first section 110 is adjacent to the hinge assembly 106. FIG. 2 depicts manual operation of the rail lock 125 of the first lock assembly 122. Manual operation provides an alternative to operation of the first lock assembly 122 via the pinch grasp portions 124. The second lock assembly 140 may be manually operated in a similar manner to that illustrated in FIG. 2.

As shown in FIG. 2, a user can manually operate the first lock assembly 122 to disengage the rail lock 125 from the opening 126 in the inner rail 118. The rail lock 125 includes a gap 148 such that a user may fit a finger between the rail lock 125 and the outer rail 114 to manually release the rail lock 125 from the openings 126, 127 (note that opening 126 in the inner rail 118 is not visible in FIG. 2). Thus, a user can still manually disengage the rail locks 125 of the locking mechanism from the openings in the inner rails 118 one at a time.

It is contemplated that, while FIGS. 1 and 2 illustrate the openings 126 in the second section 112 of the first rail assembly 102 as extending laterally through a side flange 150 of a rail, the openings 126 may alternatively extend through the front flange 152 of the rail or the rear flange (which is positioned opposite the front flange 152 and not shown in FIG. 2). When configured in this manner, the rail lock will also be adjusted to change the approach of the lock with respect to the rail so that the lock portion is configured to engage the front or rear of the rail upon actuation of the pinch grasp portion 124. One or more or, in some approaches, all openings and rail locks of the ladder 100 may be configured in this manner.

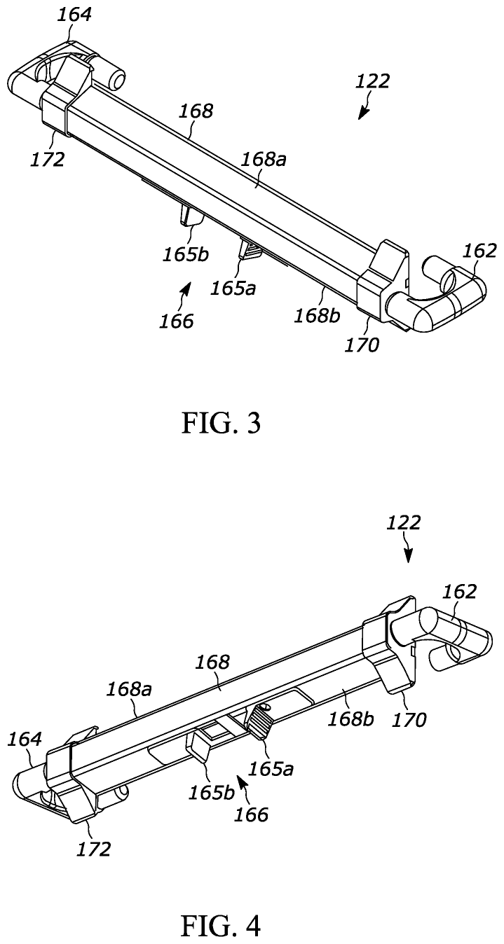

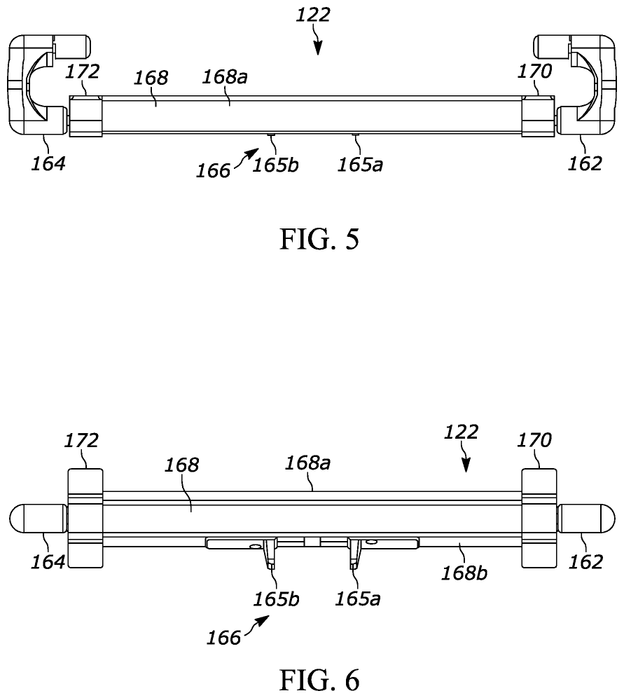

FIGS. 3-8 further illustrate the first lock assembly 122. The second lock assembly 140 is the same so only the first lock assembly 122 is shown and described in detail.

While FIGS. 1 and 2 show the first lock assembly 122 installed in a ladder 100, it is also contemplated that any portion of a railed structure may incorporate the lock assembly of FIG. 3-8. For example, the lock assembly 122 may be incorporated into a scaffold, a work platform, or similar.

Turning first to FIGS. 3-6, the first lock assembly 122 is shown in a locked position. The first lock assembly 122 includes a first j-shaped hook or j-lock 162 and a second j-shaped hook or j-lock 164 spaced from the first j-lock 162 by a first end cover 170, a housing 168, and a second end cover 172. The first lock assembly 122 also typically includes a pinch grasp portion 166 with levers 165a, 165b.

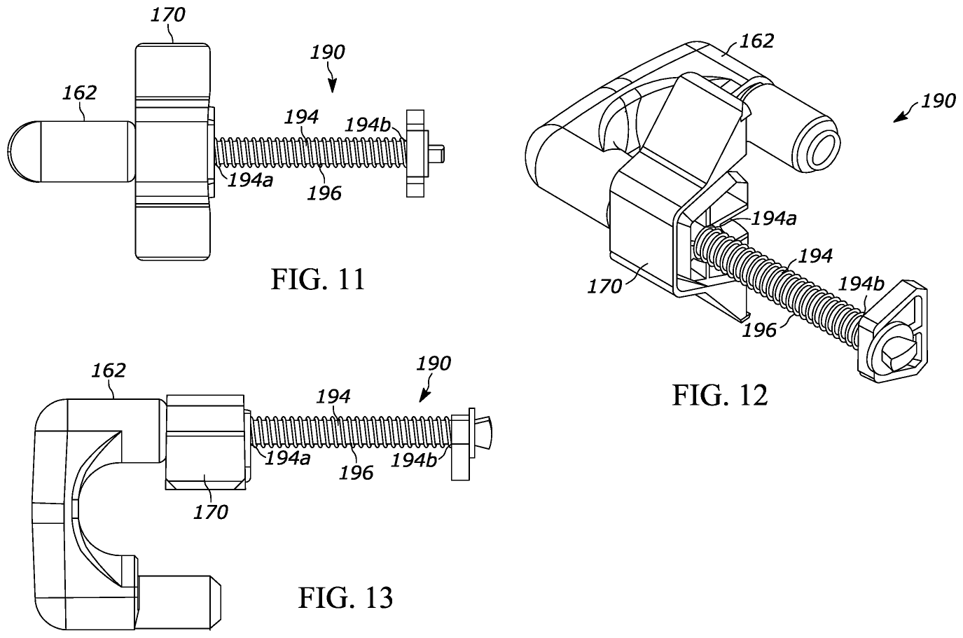

The j-locks 162, 164 (see FIGS. 11 to 13 for additional detail) include an end portion having an arm with a hook, bend, or curve therein. The end portion of the j-locks 162, 164 may act as an engagement portion that engages or is at least partially received by an opening in the rails of a rail assembly. For example, as shown in FIG. 2, the arm is received by an opening 126 in the side flange 52 of the outer rail 116. The arm may also serve as a graspable portion for a user, for example, the hook or curve in the arm may create a space or gap by which a user may pull on the end portion out of engagement with the rail to unlock the j-locks 162, 164.

When the first lock assembly 122 is installed on a railed structure such as a ladder, the first end cover 170 is seated against one rail and the second end cover 172 is seated against another rail. The housing 168 is disposed between the rails of the railed structure, with the pinch grasp portion 166 extending from a base of the housing 168 or, in some configurations, from a side of the housing 168. An exemplary installation of the first lock assembly 122 is illustrated with reference to FIGS. 1 and 2. The first end cover 170 and the second end cover 172 may act as a spacer to ensure the first j-lock 162 and the second j-lock 164, respectively, are spaced from the rail and not seated too deeply within the rail. The first end cover 170 and the second end cover 172 may also cover rivets or other portions of the assembly. The first end cover 170 and the second end cover 172 are optional and, in some configurations, a length of the housing 168 may be instead increased to adjust the spacing of the j-locks 162, 164 from the rails.

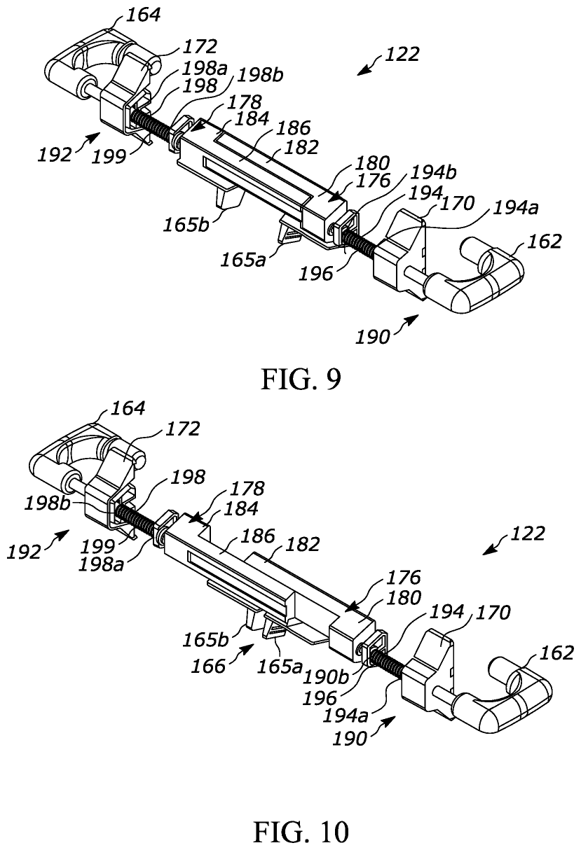

In some configurations, the housing 168 encases the first lock assembly 122. The first lock assembly 122 with the housing 168 removed is illustrated and described with reference to FIGS. 9 and 10. The housing 168 includes a planar upper surface 168a such that the housing 168 provides a stepping surface and, accordingly, may serve as a step or rung in a ladder. The levers 165a, 165b of the pinch grasp portion 166 protrude from a lower surface 168b of the housing 168, so as to not interfere with the stepping surface. The first end cover 170 and the second end cover 172 are positioned on opposite sides of the housing 168. The first end cover 170 is adjacent to the first j-lock 162. The second end cover 172 is adjacent to the second j-lock 164.

In some aspects, the housing 168, the first j-lock 162, and the second j-lock 164 may be formed of a metal material, such as steel, aluminum, or an aluminum alloy. The levers 165a, 165b and the first end cover 170 and the second end cover 172 may be formed of composite materials, plastics, polymers, metals, metal alloys, or combinations of such materials.

In the locked position, the levers 165a, 165b of the pinch grasp portion 166 are separated or spaced from each other. A user may operate the pinch grasp portion 166 when in the locked position, for example, by manually pinching or moving the levers 165a, 165b together. Accordingly, the levers 165a, 165b are typically less than a hands-width apart from one another. Moving the levers 165a, 165b towards each other disengages the first j-lock 162 and the second j-lock 164 from the rails of the rail assembly (not shown in FIGS. 3-8). When the first j-lock 162 and the second j-lock 164 disengage the rails of the rail assembly, the rail assembly is adjustable such that, for example, one section (or other portion) of the rail assembly is free to move, slide, rotate, or pivot relative to another section (or other portion) of the rail assembly.

While the first lock assembly 122 is described as being operated by a pinching action, other ways of operating the first lock assembly 122 may be employed to achieve similar one-handed operation. For example, the levers 165a, 165b may be modified to accommodate a squeezing action, a rotation action, and/or other manual displacement.

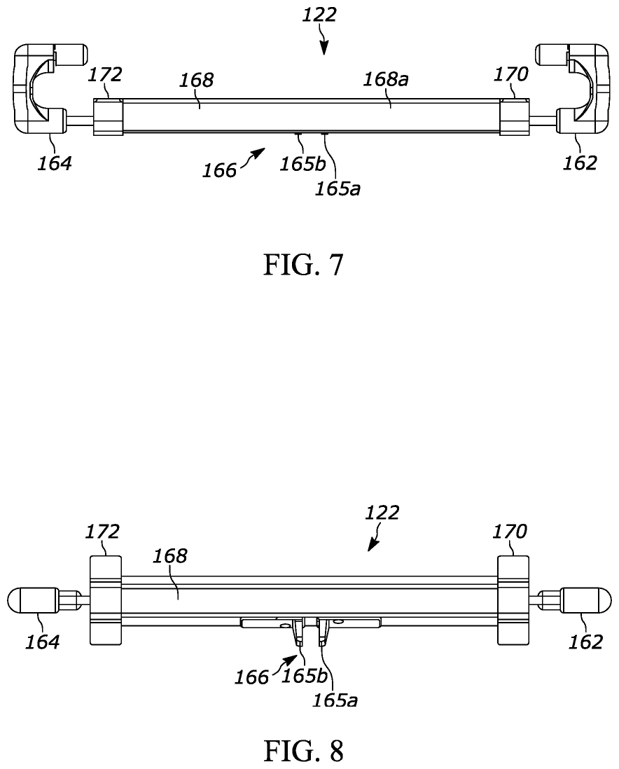

Turning next to FIGS. 7 and 8, the first lock assembly 122 is shown in an unlocked position. In the unlocked position, the levers 165a, 165b of the pinch grasp portion 166 are pinched or moved together. The levers 165a, 165b are closer to each other in the unlocked position than in the locked position. The levers 165a, 165b are also further away from the rails of the rail assembly in the locked position. In the unlocked position, there is a gap between the first j-lock 162 and the first end cover 170 such that an end of the first j-lock 162 is spaced from the rail(s) of the ladder (not shown in FIGS. 7 and 8). In this position, the end of the first j-lock 162 disengages an opening in the rail. Similarly, in the unlocked position, there is a gap between the second j-lock 164 and the second end cover 172 such that an end of the second j-lock 164 is spaced from the rail(s) of the ladder (not shown in FIGS. 7 and 8). In this position, the end of the second j-lock 164 disengages an opening in the rail. Releasing the levers 165a, 165b from the unlocked position or otherwise causing the levers 165a, 165b to move apart causes the levers 165a, 165b to return to the locked position that is depicted in FIGS. 3-6. Releasing the levers 165a, 165b causes the first j-lock 162 and the second j-lock 164 to engage the rails of a rail assembly (not shown in FIGS. 3-8). When the first j-lock 162 and the second j-lock 164 are engaged with rails of the rail assembly, the rail assembly is not adjustable, for example, one section (or other portion) of the rail assembly is secured relative to another section (or other portion) of the rail assembly.

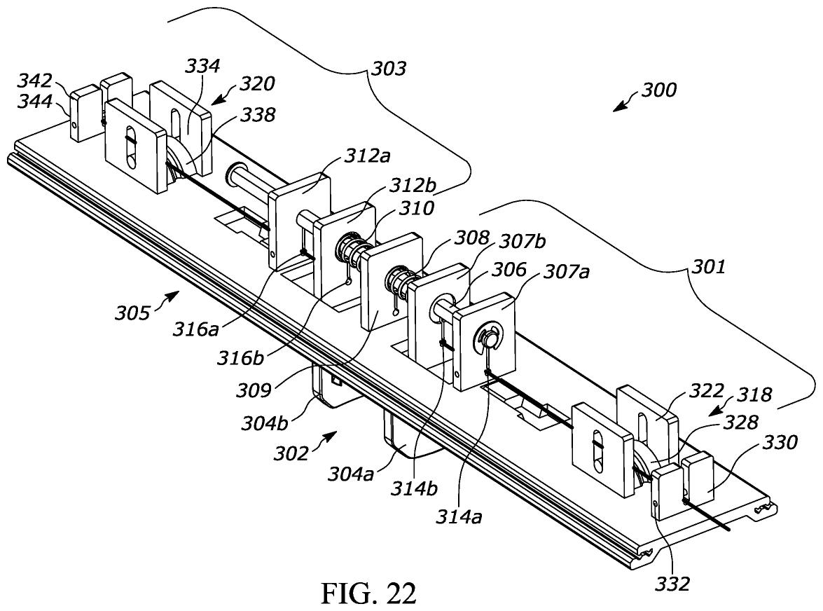

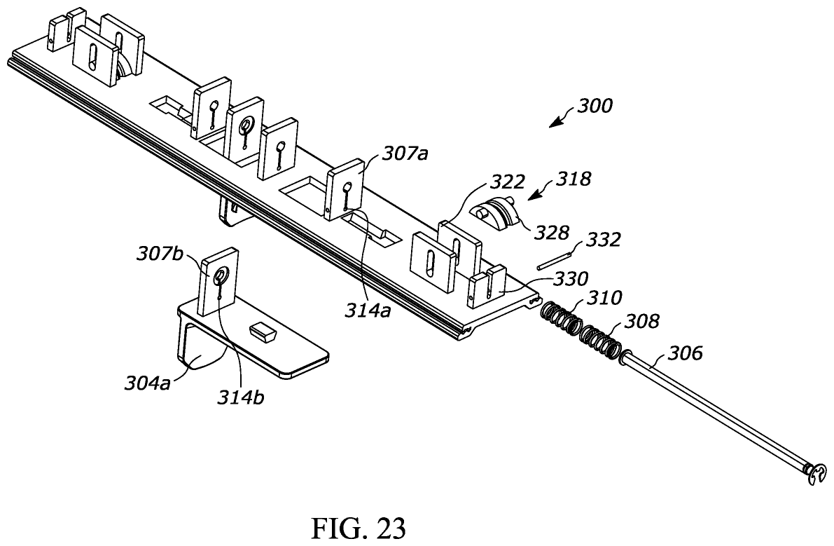

FIGS. 9 and 10 illustrate the first lock assembly 122 depicted in FIGS. 3-8 without the housing 168, in accordance with some approaches. It is contemplated that other alternative configurations or mechanisms may be employed in the first lock assembly 122 and operated by the first lever 165a and the second lever 165b of the pinch grasp portion 166. One alternative configuration is shown, for example, in FIGS. 22 and 23. FIG. 9 depicts the first lock assembly 122 in a locked position, with the first lever 165a spaced from the second lever 165b. FIG. 10 depicts the lock assembly in an unlocked position, with the first lever 165a adjacent to the second lever 165b.

The first lock assembly 122 includes a first pusher 176 and a second pusher 178. In some configurations, the first pusher 176 and the second pusher 178 are lapped by one another. By some approaches, the second lever 165b is coupled to the first pusher 176, and the first lever 165a is coupled to the second pusher 178. In this manner, the first lever 165a engages or actuates the second pusher 178 and the second lever 165b engages or actuates the first pusher 176.

In some embodiments, the first pusher 176 includes first flange portion 180 and a first leg portion 182 that extends from the first flange portion 180. The first flange portion 180 and the first leg portion 182 form an “L”-shape. The first pusher 176 is coupled to a first rail lock subassembly 190. In this manner, the first pusher 176 and the second lever 165b coupled thereto may actuate the first rail lock subassembly 190. The first rail lock subassembly 190 includes the first j-lock 162 at a proximal end of a first rod 194 that is proximal to a rail of the rail assembly (not shown). The first flange portion 180 engages the first rod 194. A first spring 196 is coupled to the first rod 194. The first spring 196 is disposed between the first end cover 170 and the first flange portion 180 of the first pusher 176. The second lever 165b extends from an outer surface of the first pusher 176. In particular, the second lever 165b engages the first leg portion 182 of the first pusher 176. As shown, the second lever 165b is disposed at a distal end of the first leg portion 182, though, the second lever 165b could be positioned anywhere along the first leg portion 182.

In some configurations, the second pusher 178 includes a second flange portion 184 and a second leg portion 186 that extends from the second flange portion 184. The second flange portion 184 and the second leg portion 186 form an “L”-shape. The second leg portion 186 of the second pusher 178 slidingly engages the first leg portion 182 of the first pusher 176. The second pusher 178 is coupled to a second rail lock subassembly 192. In this manner, the second pusher 178 and the first lever 166a coupled thereto may actuate the second rail lock subassembly 192. The second leg portion 186 of the second pusher 178 slidingly engages the first leg portion 182 of the first pusher 176. The second rail lock subassembly 192 includes the second j-lock 164 at a proximal end of a second rod 198. A second spring 199 is coupled to the second rod 198. The second spring 199 is coupled to the second j-lock 164. The first flange portion 180 is disposed between the second end cover 172 and the second flange portion 184. The first lever 165a extends from an outer surface of the second pusher 178. In particular, the first lever 165a engages the second leg portion 186 of the second pusher 178. As shown, the first lever 165a is disposed at a distal end of the second leg portion 186, though, the first lever 165a could be positioned anywhere along the second leg portion 186.

The first lock assembly 122 may be installed in a rail assembly, such as the first rail assembly 102 or the second rail assembly 104 of FIG. 1. The internal portion may be enclosed in the housing 168 or, in some aspects, may be installed as depicted in FIGS. 9 and 10 without any housing or enclosure.

When installed in a rail assembly, the first spring 196 and the second spring 199 typically bias the first pusher 176 and the second pusher 178 towards each other. In addition, the first spring 196 and the second spring 199 bias the first pusher 176 and the second pusher 178 apart in the locked position. The first end cover 170 and the first pusher 176 maintain the first spring 196 in a state of compression. The second end cover 172 and the second pusher 178 maintain the second spring 199 in a state of compression. In the compressed state, the first spring 196 urges the first pusher 176 towards the second pusher 178 and the second spring 199 urges the second pusher 178 toward the first pusher 176. With no external forces applied (e.g., manual forces from a user), the first lock assembly 122 is in the locked position that is shown in FIG. 9. In the locked position, the first lever 165a is spaced apart from the second lever 165b. In the locked position, a proximal end portion of the first rod 194 (i.e., a portion proximal to a rail) engages openings in the inner and/or outer rail of the rail assembly and a proximal end portion of the second rod 198 engages opening in the opposite inner and/or outer rail of the rail assembly.

In operation, a user may push the first lever 165a and the second lever 165b together to actuate the first lock assembly 122. Moving the first lever 165a towards the second lever 165b moves the first lock assembly 122 from the locked position to the unlocked position. Pushing the first lever 165a and the second lever 165b towards each other moves the first rod 194 and the second rod 198 outwardly, causing the first j-lock 162 and the second j-lock 164 to disengage the rails of the rail assembly (rails/rail assembly not shown in FIGS. 9 and 10). The outward motion of the first rod 194 and the second rod 198 moves the first j-lock 162 and the second j-lock 164 out of openings in the inner and/or outer rails so that a rail section to which the first lock assembly 122 is coupled is free to move.

Due to the overlapping configuration of the first pusher 176 and the second pusher 178, pushing on the first lever 165a actuates the second rail lock subassembly 192 and pushing on the second lever 165b actuates the first rail lock subassembly 190. In particular, moving the first lever 165a toward the second lever 165b causes the first flange portion 180 of the first pusher 176 to move the proximal end portion of the first rod 194 (i.e., the first j-lock 162) away from the adjacent rails such that the proximal end portion disengages from openings in the rails. Further, moving the first lever 165a toward the second lever 165b causes the second pusher 178 to move the proximal end portion of the second rod 198 (i.e., the second j-lock 164) away from another one of the rails such that the proximal end portion disengages from openings in the other rail.

So configured, it is possible to actuate both rail lock subassemblies 190, 192 at once by operating the first lever 165a and the second lever 165b of the pinch grasp portion 166. Though, in some configurations, the pinch grasp portion 166 may actuate one or more of the rail lock subassemblies 190, 192. It is contemplated that a user may manually operate the first lever 165a and the second lever 165b using a single hand, leaving one hand free to be secured to a structure or other equipment. The single-handed operation also may improve the ease and efficiency of switching a rail assembly, such as a ladder, work platform, or otherwise between different configurations. The pinch grasp portion 166 may also make operation of the rail assembly more ergonomic.

FIGS. 11-13 show details of a subassembly that includes the first j-lock 162, as employed in the first lock assembly 122. As discussed above, other suitable rail locks may be employed in place of the j-locks. The subassembly for the second j-lock 164 may be the same as that of the first j-lock 162, though, in some approaches, different components and/or subassemblies could be employed on each rail of a rail assembly.

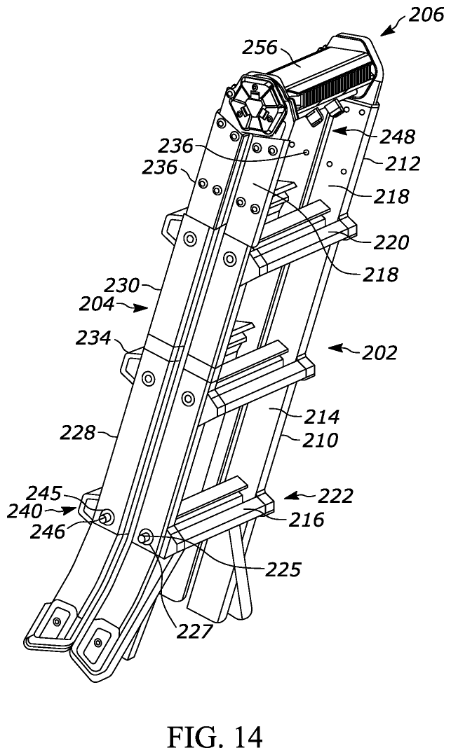

Referring now to FIGS. 14-18, a ladder 200 that includes a second embodiment of a lock assembly is shown. Two such lock assemblies are installed in the ladder 200: a first lock assembly 222 one side; and a second lock assembly 240 installed on another side. The ladder 200 further includes a hinge lock assembly 206. The lock assemblies may be employed to reconfigure or adjust the ladder 200.

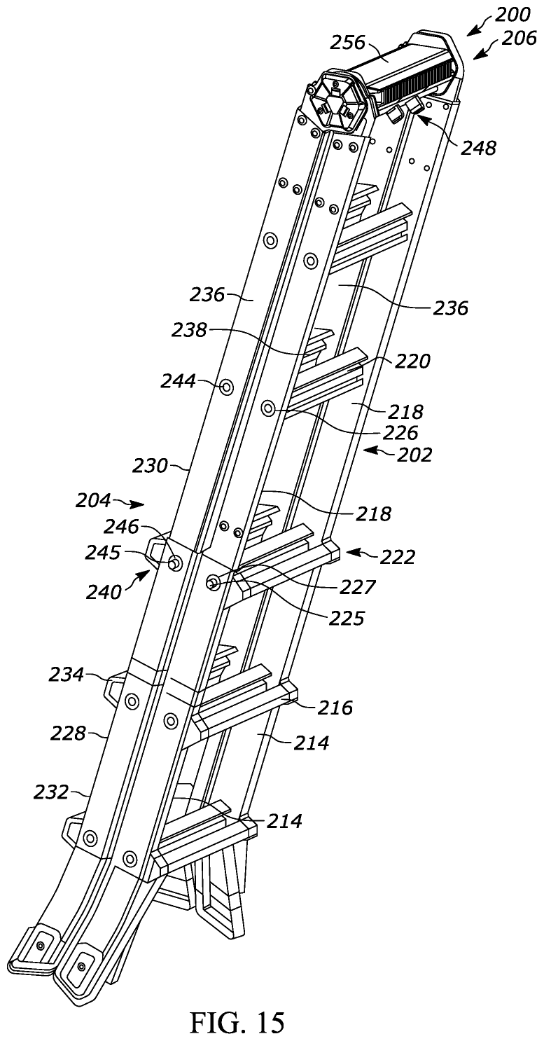

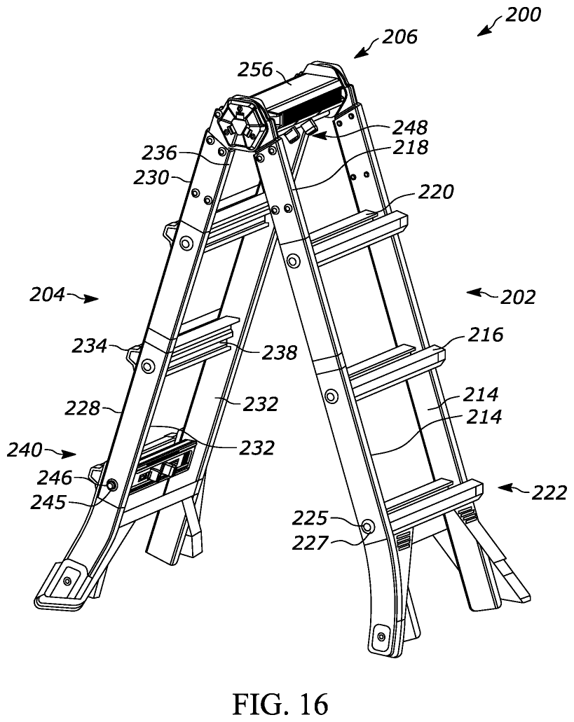

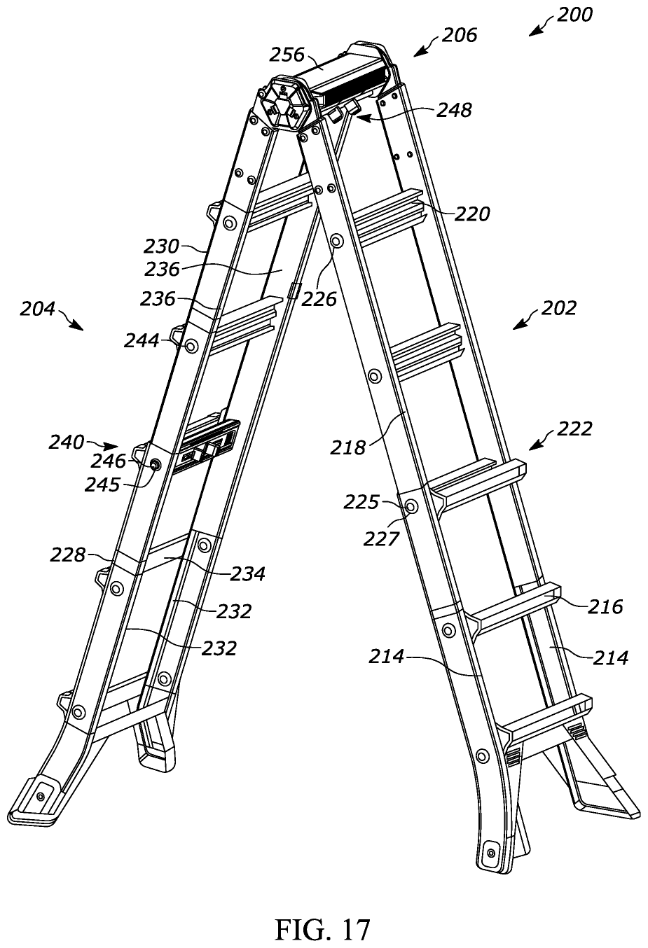

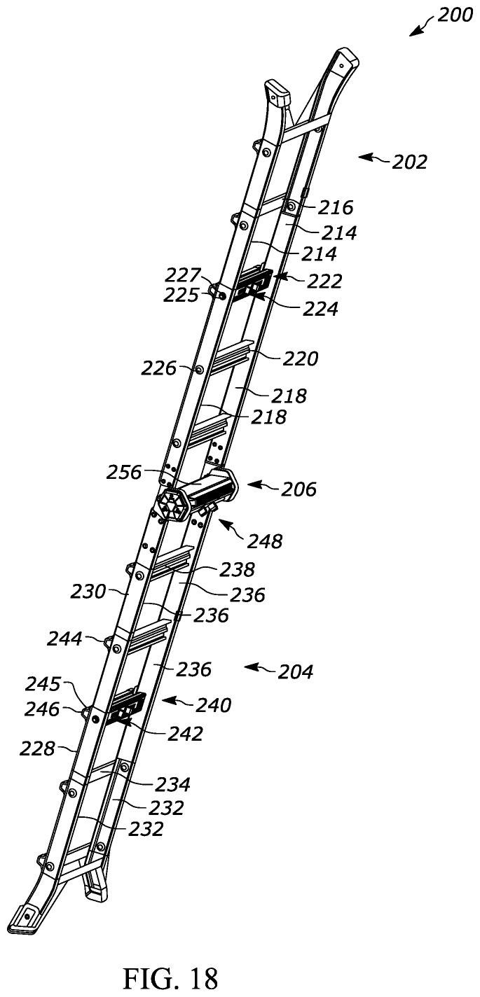

As shown, the ladder 200 is a multi-position ladder that has a number of different configurations including, among others, a wall ladder configuration (see FIGS. 14 and 15), a step ladder configuration (see FIGS. 16 and 17) and an extension ladder configuration (see FIG. 18). The ladder 200 may also be disassembled at the hinge lock assembly 206 and to create two separate bases for a work platform using a first rail assembly 202 and a second rail assembly 204.

The ladder 200 includes the first rail assembly 202 and the second rail assembly 204. The second rail assembly 204 is positioned opposite the first rail assembly 202. The hinge lock assembly 206 rotatably couples the first rail assembly 202 to the second rail assembly 204. The hinge lock assembly 206 is disposed at a top portion of the ladder 200. When in an unlocked configuration, the hinge lock assembly 206 permits the first rail assembly 202 and the second rail assembly 204 to pivot relative to each other such that an angle between the two assemblies can be adjusted. When in an unlocked configuration, the hinge lock assembly 206 secures the first rail assembly 202 relative to the second rail assembly 204.

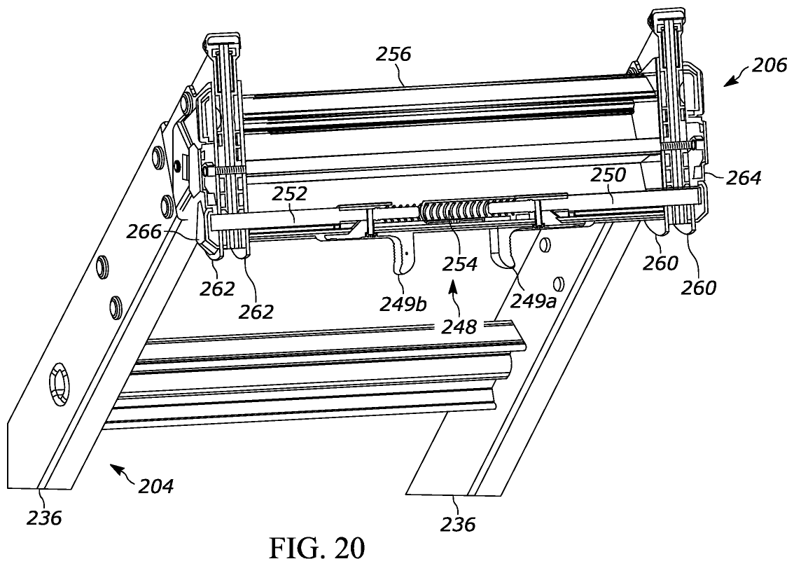

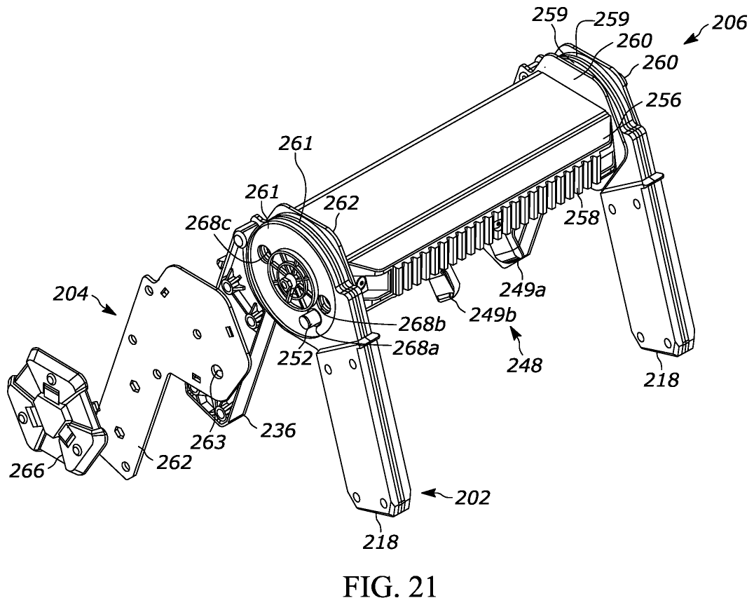

Turning momentarily to FIGS. 20 and 21, the hinge lock assembly 206 of the ladder 200 is shown. FIGS. 20 and 21 depict the hinge lock assembly 206 in a locked position. The hinge lock assembly 206 is incorporated into the hinge rung 256 (FIG. 21) of the ladder 200. The hinge rung 256 may optionally include a bumper 258 (shown in FIG. 21), for example, for protecting a wall when the ladder 200 is configured as wall ladder. The hinge rung 256 includes a planar upper surface that may serve as a stepping surface, for example, when the ladder 200 is configured as an extension ladder. A pinch grasp portion 248 extends from a bottom portion of the hinge rung 256. The pinch grasp portion 248 includes a first lever 249a and a second lever 249b. In some configurations, the pinch grasp portion 248 may extend from other portions of the hinge rung 256, such as, for example, a side portion.

The hinge lock assembly 206 is disposed between hinge plates that are coupled to the inner rails 218, 236 of the rail assemblies 202, 204. A first pair of inner hinge plates 259 and a second pair of inner hinge plates 261 are coupled to the inner rails 218 of the first rail assembly 202. A first pair of outer hinge plates 260 and a second pair of outer hinge plates 262 are coupled to the inner rails 236 of the second rail assembly 204. The first pair of inner hinge plates 259 are seated within the first pair of outer hinge plates 260. The inner hinge plates 259 and the outer hinge plates 260 include position holes (not visible in FIG. 20). The second pair of inner hinge plates 261 are seated within the second pair of outer hinge plates 262. The inner hinge plates 261 include three position holes including a first position hole 268a, a second position hole 268b, and a third position hole 268c. The outer hinge plates include a position hole 263. Though not visible in FIGS. 20 and 21, the inner hinge plates 259 include position holes similar to the first position hole 268a, the second position hold 268b, and the third position hole 268c. Likewise, the outer hinge plates 260 includes a position hole similar to position hole 263. The position holes in the first pairs of hinge plates 259, 260 are aligned with the position holes in the second pairs of hinge plates 261, 262. Thus, a first rod 250 and a second rod 252 will engage the corresponding position holes on each side of the ladder (i.e., the hinge plates 259, 260 on one side and the hinge plates 261, 262 on the other side). Three position holes are shown in FIG. 21, however, it is contemplated that any number of position holes 268 may be included in the hinge plates depending on the desired configurations for a particular ladder. Likewise, the second pair

The hinge lock assembly 206 includes the first rod 250 and the second rod 252 that selectively engage the position holes in the hinge plates. For example, the second rod 252 may selectively engage one of the first position hole 268a, the second position hole 268b, and the third position hole 268c in the inner hinge plates 261 to adjust the position of the first rail assembly 202 with respect to the second rail assembly 204. Further, the second rod 252 will engage the position hole 263 in the outer hinge plates 262 when the hinge lock assembly 206 is in a locked position. A spring 254 is disposed between the first rod 250 and the second rod 252. When the hinge lock assembly 206 is installed between the first pairs of hinge plates 259, 260 and the second pairs of hinge plates 261, 262, the spring 254 is in a compressed state. Thus, the spring 254 biases the first rod 250 and the second rod 252 outwardly to engage the position holes in the hinge plates in a locked position. The first rod 250 is coupled to the first lever 249a of the pinch grasp portion 248. The second rod 252 is coupled to the second lever 249b of the pinch grasp portion 248. Thus, biasing the first rod 250 and the second rod 252 outwardly also biases the first lever 249a and the second lever 249b outwardly such that the first lever 249a is spaced from the second lever 249b in the locked position. The first lever 249a is further from the second lever 249b in the locked position than in the unlocked position. In this manner, the spring 254 biases the hinge lock assembly 206 in the locked position.

In operation, pinching or otherwise moving the first lever 249a of the pinch grasp portion 248 towards the second lever 249b compresses the spring 254 and moves the first rod 250 and the second rod 252 inwardly. Moving the first rod 250 and the second rod 252 inwardly causes the first rod 250 to disengage the first set of hinge plates 259, 260 and causes the second rod 252 to disengage the second pairs of hinge plates 261, 262. In this manner, pinching the first lever 259a and the second lever 259b together places the hinge lock assembly in an unlocked position. From the unlocked position, the first rail assembly 202 and/or the second rail assembly 204 are free to move and align the first rod 250 and the second rod 252 with a particular pair of position holes in the hinge plates.

When the hinge lock assembly 206 is in the unlocked position, a user is free to reconfigure the first rail assembly 202 and the second rail assembly 204 relative to each other, thereby adjusting an angle therebetween. In particular, a user may pinch or otherwise operate the pinch grasp portion 248 of hinge lock assembly 206, which moves the first rod 250 and the second rod 252 inwardly unlocking the hinge lock assembly 206.

In a first configuration, the first rail assembly 202 and the second rail assembly 204 are positioned such that the second rod 252 engages the first position hole 268a in the inner hinge plates 261 and the first rod 250 engages a corresponding position hole in the inner hinge plates 259. The second rod 252 also engages the position holes 263 in the outer hinge plates 262 and the first rod 250 engages corresponding position holes in the outer hinge plates 260. The first configuration places the ladder 200 in an unfolded position and configures the ladder 200 as a stepladder (see FIGS. 16 and 17).

In a second configuration, the first rail assembly 202 and the second rail assembly 204 are positioned such that the second rod 252 engages the second position hole 268b in the inner hinge plates 261 and the first rod 250 engages a corresponding position hole in the inner hinge plates 259. The second rod 252 also engages the position holes 263 in the outer hinge plates 262 and the first rod 250 engages corresponding position holes in the outer hinge plates 260. The second configuration places the ladder in a folded position (see FIGS. 14 and 15).

In a third configuration, the first rail assembly 202 and the second rail assembly 204 are positioned such that the second rod 252 engages the third position hole 268c in the inner hinge plates 261 and the first rod 250 engages a corresponding position hole in the inner hinge plates 259. The second rod 252 also engages the position holes 263 in the outer hinge plates 262 and the first rod 250 engages corresponding position holes in the outer hinge plates 260. The third configuration places the ladder in an unfolded position and configures the ladder as an extension ladder (see FIG. 18).

Returning to FIGS. 14-18, the first rail assembly 202 includes a first section 210 and a second section 212. The first section 210 is the lower of the two adjacent sections, from which the second section 212 is extended upward. The first section 210 includes a pair of outer rails 214 having a plurality of rungs 216 disposed therebetween. The second section 212 includes a pair of inner rails 218 having a plurality of rungs 220 disposed therebetween. The outer rails 214 of the first section 210 telescopingly engage the inner rails 218 of the second section 212. The outer rails 214 slidingly engage the inner rails 218 such that the second section 212 can be adjusted to different heights.

The first rail assembly 202 further includes a first lock assembly 222 that selectively engages the inner rails 218 and the outer rails 214. The first lock assembly 222 is integrated into one of the plurality of rungs 220 of the second section 212. While the first lock assembly 222 is integrated into the bottommost of the rungs 120 in FIGS. 14-18, it is contemplated that, in other approaches, the first lock assembly 222 could be integrated into any one of the rungs 220 of the second section 212. The first lock assembly 222 includes a pair of rail locks 225 configured to selectively engage the inner rails 218 and the outer rails 214. The first lock assembly 222 also includes a pinch grasp portion 224 coupled to the pair of rail locks 225.

The pinch grasp portion 224 operates the first lock assembly 222 to selectively engage the rail locks 225 with the inner rails 218 and/or the outer rails 214. The inner rails 218 of the second section 212 include pairs of openings 226 that are disposed on each side of the rungs 220. Further, the outer rails 214 include pairs of openings 227 that are disposed on each side of the rungs 220. Operating the pinch grasp portion 224 actuates the rail locks 225 to move the rail locks 225 between a locked position and an unlocked position. In the locked position, the rail locks 225 engage one of the pairs of openings 226 in the inner rails 218 of the second section 212 and also engage one of the pairs of openings 227 in the first section 210 when the openings 226, 227 are aligned. In the unlocked position, the rail locks 225 disengage the pairs of openings 226 in the inner rails 218 of the second section 212 and also disengage the pair of openings 227 in the first section 210.

The second rail assembly 204 also includes a first section 228 and a second section 230. The first section 228 includes a pair of outer rails 232 having a plurality of rungs 234 disposed therebetween. The second section 230 includes a pair of inner rails 236 having a plurality of rungs 238 disposed therebetween. The outer rails 232 of the first section 228 telescopingly engage the inner rails 236 of the second section 230. The outer rails 232 slidingly engage the inner rails 236 such that the second section 230 can be adjusted to different heights.

The second rail assembly 204 further includes a second lock assembly 240 that selectively engages the inner rails 236 and the outer rails 232. The second lock assembly 240 is built into one of the plurality of rungs 234 in the second section 230. While the second lock assembly 240 is integrated into the bottommost of the rungs 238 in FIGS. 14-18, it is contemplated that, in other approaches, the second lock assembly 240 could be integrated into any one of the rungs 238 of the second section 230. The second lock assembly 240 includes a pair of rail locks 246 configured to selectively engage the inner rails 236 and the outer rails 232. The second lock assembly also includes a pinch grasp portion 242 coupled to the pair of rail locks 246.

The pinch grasp portion 224 operates the second lock assembly 240 to selectively engage the rail locks 246 with the inner rails 236 and/or the outer rails 232. The inner rails 236 of the second section 230 includes openings 244 disposed on each side of the rungs 238. Further, the outer rails 232 include pairs of openings 245 that are disposed on each side of the rungs 234. Operating the pinch grasp portion 242 actuates the rail locks 246 to move the rail locks 246 between a locked position and an unlocked position. In the locked position, the rail locks 246 engage a pair of openings 244 in the inner rails 236 of the second section 230 and also engage a pair of openings 245 in the first section 228 when the openings 244, 245 are aligned. In the unlocked position, the rail locks 246 disengage a pair of openings 244 in the inner rails 236 of the second section 230 and also disengage the pair of openings 245 in the first section 228.

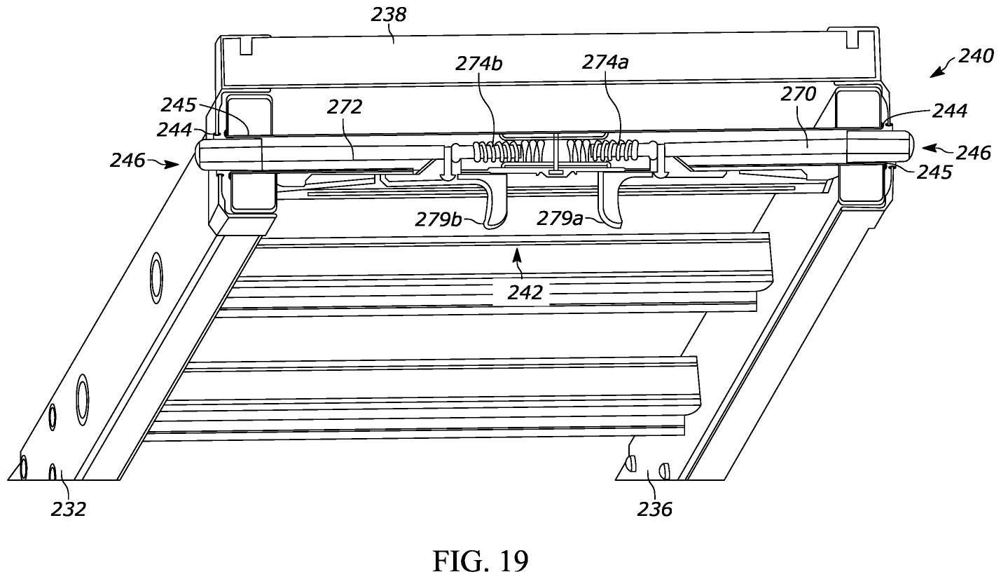

Turning to FIG. 19, the second lock assembly 240 is shown in detail. The second lock assembly 240 includes a first rod 270 and a second rod 272 that selectively engage openings in the rails. A first spring 274a and a second spring 274b are disposed between the first rod 270 and the second rod 272. The first spring 274a is coupled to the first rod 270. The second spring 274b is coupled to the second rod 272. When the second lock assembly 240 is installed between the inner rails 236, the spring 274 is in a compressed state. Thus, the first spring 274a and the second spring 274b bias the first rod 270 and the second rod 272 outwardly to engage openings in the inner rails 236 and the outer rails 232. This outward displacement of the rods 270, 272 by the springs 274a, 274b biases the second lock assembly 240 in a locked position.

The pinch grasp portion 242 depends from the rung 238 of the inner rails 236. The first lever 279a is coupled to the first rod 270 of the pinch grasp portion 242. The second lever 279b is coupled to the second rod 272 of the pinch grasp portion 242. Thus, biasing force of the springs 274a, 274b also biases the first lever 279a and the second lever 247b outwardly such that the first lever 279a is spaced from the second lever 279b. In this manner, the springs 274a, 274b bias the hinge lock assembly 206 in the locked position.

In operation, pinching the pinch grasp portion 242 (or moving the first lever 279a towards the second lever 279b in any other manner) actuates the first rod 270 and the second rod 272 of the second lock assembly 240. In particular, pinching the pinch grasp portion 242 compresses the first spring 274a and the second spring 274b, causing the first rod 270 and the second rod 272 to move inwardly and disengage the openings 244 in the inner rails 236 and the openings 245 in the outer rails 232. Thus, pinching the pinch grasp portion 242 places the second lock assembly 240 in an unlocked position. In the unlocked position, the inner rails 236 may telescope into or out of the outer rails 232 to adjust a height of the second rail assembly 204.

FIGS. 22 and 23 illustrate a third embodiment of a lock assembly 300 for a rail assembly. The rail assembly may be a section of a ladder, a scaffold, a work platform, or other railed structure.

The lock assembly 300 includes a pinch grasp portion 302 a having a first lever 304a and a second lever 304b that extends from a bottom surface of a platform 305. The platform 305 includes a first pair of supports 307a, 307b and a second pair of supports 312a, 312b that extend from a top surface of the platform 305. The first pair of supports 307a, 307b and the second pair of supports 312a, 312b are configured to receive a rod 306. A first spring 308 and a second spring 310 are disposed around the rod 306. The first spring 308 is positioned between a central support 309 and the support 307b. The second spring 310 is positioned between the central support 309 and the support 312b. The lock assembly 300 further includes a first cable assembly 301 and a second cable assembly 303 that are operated by the pinch grasp portion 302.

The first cable assembly 301 includes the first pair of supports 307a, 307b, a first tensioning assembly 318, and a first guide post 330. The first pair of supports 307a, 307b include openings 314a, 314b that receive a first cable. The first tensioning assembly 318 includes a first frame 322 and a first tensioner body 328 that is mounted in the first frame 322. The first tensioner body 328 has a channel formed therein to receive the first cable. A first guide post 330 is positioned adjacent to the first tensioner body 328 to guide the first cable along a desired path across the end of the platform 305. The first guide post 330 includes a notch that receives the first cable. The first tensioning assembly 318 is positioned between the support 307a and the first guide post 330 such that the tensioning assembly may pick up any slack in the first cable that develops, for example, due to aging or normal wear and tear. The first cable runs through the openings 314a, 314b in the first pair of supports 307a, 307b over the first tensioner body 328 and through the notch in the first guide post 330. A pin 332 is mounted in the first guide post 330 and is positioned above the first cable to secure the first cable in the first guide post 330. One end of the first cable is affixed to the support 307b while the other end is affixed to a lock, such as a rod, that engages a rail of the rail assembly.

In some configurations, a biasing element (not shown) is disposed between the platform 305 and the first tensioner body 328 to exert a biasing force on the first tensioner body 328 that urges the first tensioner body 328 upward such that the first tensioner body 328 creates tension in the first cable. The biasing element may be, for example, a spring.

The second cable assembly 303 includes the second pair of supports 312a, 312b, a second tensioning assembly 320, and a second guide post 342. The second pair of supports 312a, 312b include openings 316a, 316b that receive a second cable. The second tensioning assembly 320 includes a second frame 334 and a second tensioner body 338. The second tensioner body 338 is mounted in the second frame 334. The second tensioner body 338 has a channel formed therein to receive the second cable. A second guide post 342 is positioned adjacent to the second tensioning assembly 320 to guide the second cable along a desired path across the end of the platform 305. The second guide post 342 includes a notch that receives the second cable. The second tensioning assembly 320 is positioned between the support 312a and the second guide post 342 such that the second tensioning assembly 320 may pick up any slack in the second cable that develops, for example, due to aging or normal wear and tear. The second cable runs through the openings 316a, 316b in the second pair of supports 312a, 312b over the second tensioner body 338 and through the notch in the second guide post 342. A pin 344 mounted in the second guide post 342 and is positioned above the second cable to secure the second cable in the second guide post 342. One end of the second cable is affixed to the support 312b while the other end is affixed to a rail lock, such as a rod, that engages a rail of the rail assembly.

In some configurations, a biasing element (not shown) is disposed between the platform 305 and the second tensioner body 338 to exert a biasing force on the second tensioner body 338 that urges the second tensioner body 348 upward such that the second tensioner body 338 creates tension in the second cable. The biasing element may be, for example, a spring.

When installed in the rail assembly, the lock assembly 300 is positioned between two rails. It is contemplated that lock assembly 300 may be installed on either inner rails or outer rails of a rail assembly that includes multiple sections. In some approaches, the lock assembly may be installed in a rung of the rail assembly and serve to lock sections of a ladder. In other approaches, the lock assembly may be installed in a hinge rung and serve as a hinge lock for a ladder.

In operation, pinching the pinch grasp portion 302 (or otherwise moving the first lever 304a towards the second lever 304b) compresses the first spring 308 and the second spring 310 and moves the support 307b and the support 312b together. Moving the support 307b and the support 312b together pulls an end of the first cable (which is affixed to the support 307b) and an end of the second cable (which is affixed to the support 312b) together. Pulling on the first cable and the second cable inward towards each other causes the cables to disengage the rail locks from the rails of the rail assembly.

It is contemplated that any suitable inline tensioner may be employed in the lock assembly 300 to pick up slack in the cable. The tensioning assemblies 318, 320 provide one illustrative embodiment.

The ladders, components, and/or accessories described herein may be formed of a variety of materials and using a variety of manufacturing techniques. Such materials may include, e.g., metals, plastics and other polymers, and/or composite materials. In addition, some portions of the ladder's components may be formed of one material and one or more other components or accessories may be formed of another similar, or entirely distinct material. In some configurations, the rails of the ladders may be formed of composite material such as fiberglass or fiberglass reinforced plastic (FRP) and may be manufactured via a pultrusion process. FRP materials may include various plastic resins, such as polyurethane or polyethylene, or may include various glass materials. It is contemplated that adjusting the FRP formula to use different material combinations may reduce material weight and/or cost. The rails may also be formed of a metal material such as steel, aluminum, or aluminum alloys and manufactured via an extrusion process. After extrusion or pultrusion, the ladder rails are typically cut to length. For box-shaped rails, a computerized numerical control (CNC) machine may machine or form one or more holes in the rails. For rails of other shapes, such as C-shaped or I-beam shaped rails, other tools such as a punch press may be leveraged to punch one or more holes into the rails.

The rungs of the ladders may be formed of composite materials such as fiberglass or carbon fiber. In some approaches, the rungs may also be formed of meatal materials such as steel, magnesium, magnesium alloys, aluminum, or aluminum alloys. The rungs may be manufactured, for example, via an extrusion process and cut to length. The rungs may take a variety of shapes and may be, for example, rounded, D-shaped, or triangular.

The rungs of a ladder may be attached to the rails in a variety of different manners. In one approach, the rungs and rails are forged together, such as by having the rungs being attached to the rails via a direct swage connection. In a direct swage connection, a rung is attached directly to the rails using a cold forming process, where a moving die shapes the rung around a hole that was pre-punched in the rail. Annealing operations may be used to soften the metal to prevent cracking. In other approaches, the rungs are attached to the rails via a rung-plate connection in addition to other attachment types. In a rung-plate connection, a rung is attached to a plate and the plate is attached to the rail via one or more rivets or other mechanical elements.

Other accessories and assemblies employed in the ladder, such as feet, locks, ropes, rope pullies, end caps, and/or knee braces may be made of materials such as rubber or plastics like polypropylene or any other suitable plastics. Plastic parts may be injection molded or insert molded. In some approaches, accessories and assemblies such as guide brackets, feet, knee braces, and/or locks, may be formed, extruded or stamped, from metal materials such as aluminum, aluminum alloys, or steel. Rubber feet may be riveted to a base of the ladder. Metal locks may be extruded and then cut to length. Rope pulleys may include extruded metal side portions and plastic round pulleys formed of injection molded plastic, with the side portions and pulley held together by a rivet. End caps may be riveted or snap fit to the ladder during assembly. Similarly, knee caps may be riveted to the ladder.

In some aspects, in accordance with the teachings herein, the ladder comprises a front section having a front base section having a first base front rail and a second base front rail and base rungs attached to and between the first base front rail and the second base front rail. The front section having a front fly section having a first fly front rail and a second fly front rail and fly rungs attached to and between the first fly front rail and the second fly front rail. The front fly section movably attached to the front base section to vary a length of the front section with the first base front rail adjacent to the first fly front rail and the second base front rail adjacent to the second fly front rail. The ladder comprises a front section lock for locking and unlocking the front fly section with the front base section. The ladder comprises a rear section having a rear base section having a first base rear rail and a second base rear rail and base rungs attached to and between the first base rear rail and the second base rear rail. The rear section having a rear fly section having a first fly rear rail and a second fly rear rail and fly rungs attached to and between the first fly rear rail and the second fly rear rail. The rear fly section movably attached to the rear base section to vary a length of the rear section with the first base rear rail adjacent to the first fly rear rail and the second base rear rail adjacent to the second fly rear rail. The ladder comprises a rear section lock for locking and unlocking the rear fly section with the rear base section. The ladder comprises a first hinge attached to the first fly front rail and the first fly rear rail. The ladder comprises a second hinge attached to the second front rail and the second rear rail. Each hinge having a locked state, and an unlocked state to allow the rear section to rotate relative to the front section while in the unlocked state and be in a locked state in a leaning position, a stepladder position or an extension ladder position. The ladder comprises a hinge rung attached to and extending between the first hinge and the second hinge. The hinge rung having a flat portion which contacts the structure when the ladder is in a leaning position with the rear section adjacent to and in parallel with the front section and leaning against the structure with the flat portion of the hinge rung contacting the structure. The ladder comprises a top lock assembly disposed with the hinge rung and engaged with the first hinge and the second hinge. The top lock assembly unlocks and locks the first hinge and the second hinge from the locked state to the unlocked state and from the unlocked state to the locked state.

The top lock assembly may include a top actuator which is attached to the top lock assembly to move the top lock assembly between the locked state and the unlocked state when actuated. The front section lock may have a section lock actuator to move the front section lock between the locked state and the unlocked state when actuated. The rear section lock also has a section lock actuator to move the rear section lock between the locked state and the unlocked state when actuated. The first hinge may have a front rail hinge portion which is fixedly attached to the first front rail and has a front slot. The first hinge may have a rear rail hinge portion fixedly attached to the first rear rail and pivotally attached to the front rail hinge portion to rotate relative to the front rail hinge portion. The rear rail hinge portion having a plurality of rear slots. Each rear slot of the plurality of slots corresponding with a desired position of the first rear rail relative to the first front rail. The front rail hinge portion has an outer and an inner plate each with a front slot that align. The rear rail hinge portion has an outer and an inner plate each with a plurality of rear slots which align. The top lock assembly and the front section lock each may include a right rod and a left rod.

The right rod of the top lock assembly may extend into one rear slot of the plurality of rear slots and the front slot of the first hinge. The left rod of the top lock assembly may extend into one rear slot of the plurality of rear slots in the front slot of the second hinge when the top lock assembly is in the locked state. The right rod of the front section lock may extend into a slot of the first base front rail and the first fly front rail. The left rod of the front section lock may extend into a slot of the second base front rail and the second fly front rail when the front section lock is in the locked state. The first rear section lock operates the same as the front section lock operates. The top lock assembly may include a top spring disposed in the hinge rung between the right rod and the left rod which biases the right rod into one slot of the plurality of slots of the first hinge and into the locked state by maintaining the right rod in the one slot of the first hinge, and which biases the left rod into one slot of the plurality of slots of the second hinge and into the locked state by maintaining the left rod in the one slot of the left hinge.

The front rail hinge portion may comprise a front outer hinge plate and a front inner hinge plate in spaced relation and in parallel and in alignment with the front outer hinge plate. The front outer hinge plate and front inner hinge plate each having a head and a tail. The head of the front outer hinge plate and the head of the front inner hinge plate each having a front slot which align. The rear rail hinge portion comprises a rear outer hinge plate and a rear inner hinge plate in spaced relation and in parallel and alignment with the rear outer hinge plate. The rear outer hinge plate and the rear inner hinge plate each having a head and a tail. The head of the rear outer hinge plate and the head of the rear inner hinge plate each having a first rear slot, a second rear slot and a third rear slot so that when the first base front rail and the first base rear rail are locked in a leaning ladder position, where the first base rear rail is adjacent to and in parallel with the first base front rail, the right rod is disposed in the front slot of the front outer hinge plate and the front inner hinge plate and the first rear slot of the rear inner hinge plate and the rear outer hinge plate in the locked state. When the first base front rail and the first base rear rail are locked in a stepladder position, where the first base rear rail forms an acute angle with the first base front rail, the right rod is disposed in the second rear slot of the rear inner hinge plate and the rear outer hinge plate in the locked state. When the first base front rail and the first base rear rail are locked in a straight ladder position, where the first base rear rail forms a straight angle with the first base front rail, the right rod is disposed in the third rear slot of the rear inner hinge plate and the rear outer hinge plate in the locked state; the rear inner hinge plate and the rear outer plate disposed between the front inner hinge plate and the front outer hinge plate. The tail of the front outer hinge plate and the tail of the front inner hinge plate may attach to the first base front rail, and the head of the front outer edge plate and the head of the front inner hinge plate create a gap. The head of the rear inner hinge plate and the head of the rear outer hinge plate are disposed in the gap. The head of the front inner hinge plate and the front outer hinge plate and the rear inner hinge plate and the rear outer hinge plate each have a pivot hole which align. There may be a pivot pin which extends through the pivot hole of all the heads. The rear and front inner and outer hinge plates able to rotate about the pivot pin. The tail of the rear inner hinge plate and the tail of the rear outer hinge plate may attach to the first fly rear rail.

The top actuator may include a right lever attached to the right rod and a left lever attached to the left rod. When the top actuator is actuated, the right and left levers are moved together causing the right rod and the left rod to move inwards toward each other, causing the spring between them to compress, and causing the right rod and the left rod to move out of any slots in the first hinge and second hinge, respectively, so the top lock assembly are in the unlocked state. When the right and left levers are released, the spring causes the right and left rod to move back into the first and second hinges and place the first and second hinges in the locked state. The section locks and section actuator operate in the same way as the top lock assembly and the top actuator, except that instead of slots in the first and second hinges, the right rod and the left rod extend into or retract from slots in the rails. The first rear slot and the front slot may be in alignment when the first base front rail and the first base rear rail are in the leaning ladder position. When the top actuator is actuated, the first and second hinges may be simultaneously changed between the lock state and the unlocked state. When the front section actuator is actuated, the right rod and the left rod may be simultaneously changed between the lock state and the unlocked state.

The front section lock may include a first J lock attached to the right rod and a second J lock attached to the left rod. The first J lock slides in and out of a slot in the first front base rail and the first front fly rail and the second J lock slides in and out of a slot in the second front base rail and the second front fly rail to place the front section lock in either the locked state or unlocked state. The front section may include a first pusher attached to the right rod. The right rod attached to the first J lock with the right rod disposed between the first pusher and the first J lock, and a second pusher attached to the left rod. The left rod attached to the second J lock with the left rod disposed between the second pusher and the second J lock. There is a first J spring positioned about the right rod and a second J spring positioned about the left rod.

The section lock actuator may include a right lever attached to the first pusher and a left lever attached to the second pusher. When the section lock actuator is actuated, the right and left levers are moved together causing the right rod and the left rod to move outwards away from each other, causing the first and second J springs to compress, and causing the first J lock and the second J lock to move out of any slots in the first front base and fly rails and the second front base and fly rails, respectively, so the section lock assembly is in the unlocked state. When the right and left levers are released, the first and second J springs cause the first and second J locks to move back into the first front base and fly rails and the second front base and fly rails and place the section lock actuator in the locked state. The front section lock may be disposed in one front fly rung of the plurality of front fly rungs.

In some aspects, the teachings herein pertain to a method for using a multi-position ladder. The method comprises the steps of actuating a section lock actuator attached to a front section lock of the ladder causing a first front fly section and first front base section to move between a locked state and an unlocked state. There is the step of moving the first front fly section relative to the first front base section. There is the step of locking the first front fly section to the first front section in the desired ladder mode.

In some aspects, the teachings herein pertain to a method for using a multi-position ladder. The method comprises the steps of actuating a top lock actuator attached to a top locking assembly in a hinge rung of the ladder causing a first hinge and a second hinge of the ladder attached to the hinge rung to move between a locked state and an unlocked state. There is the step of moving a rear section relative to the front section about the first and second hinges when the first and second hinges are in the unlocked state to either a leaning ladder mode, a stepladder mode, a stairway ladder mode, and a straight ladder mode. The front and rear sections attached to the first and second hinges. There is the step of locking the rear section relative to the front section in the desired ladder mode.

In some aspects, the teachings herein pertain to a method for producing a multi-position ladder. The method comprises the steps of attaching a hinge rung to a first hinge of the ladder. The hinge rung having a top lock assembly with a top actuator to a rung on a front section of the ladder. The actuator causes a first hinge and a second hinge of the ladder to move between a locked state and an unlocked state. There is the step of attaching the hinge rung to a second hinge of the ladder.

In some aspects, the teachings herein relate to an MT type ladder which uses one handed pinch levers to actuate the ladder hinge, and, to unlock the sections for extending them. Two different pinch lock techniques are described. In addition, a rung is positioned at the hinges which has a bumper which permits the ladder to be leaned against a supporting surface such as a wall if desired. The lock assemblies described herein allow both hinge locks to be unlocked simultaneously with one hand. Releasing the pinch levers permits both hinges to lock in the desired orientation.

In some aspects, the lock assemblies described herein will unlock the outer section through actuating the pinch levers with one hand. Releasing the pinch levers permits the outer section to lock in the desired location. Two different mechanisms for accomplishing the section locking are disclosed in the attached documents.

One handed actuation of the hinge locks and section locks makes the operation of the ladder much more convenient for the user. The hinge rung bumper prevents marring of walls etc., when the ladder is used in leaning mode and provides for better traction in holding the ladder.

In some aspects, multi-position ladder comprises: a front section having a front base section having a first base front rail and a second base front rail and base rungs attached to and between the first base front rail and the second base front rail, the front section having a front fly section having a first fly front rail and a second fly front rail and fly rungs attached to and between the first fly front rail and the second fly front rail, the front fly section movably attached to the front base section to vary a length of the front section with the first base front rail adjacent to the first fly front rail and the second base front rail adjacent to the second fly front rail; a front section lock for locking and unlocking the front fly section with the front base section; a rear section having a rear base section having a first base rear rail and a second base rear rail and base rungs attached to and between the first base rear rail and the second base rear rail, the rear section having a rear fly section having a first fly rear rail and a second fly rear rail and fly rungs attached to and between the first fly rear rail and the second fly rear rail, the rear fly section movably attached to the rear base section to vary a length of the rear section with the first base rear rail adjacent the first fly rear rail and the second base rear rail adjacent the second fly rear rail; a rear section lock for locking and unlocking the rear fly section with the rear base section; a first hinge attached to the first fly front rail and the first fly rear rail; a second hinge attached to the second front rail and the second rear rail, each hinge having a locked state and an unlocked state to allow the rear section to rotate relative to the front section while in the unlocked state and be in a locked state in a leaning position, a stepladder position and an extension ladder position; a hinge rung attached to and extending between the first hinge and the second hinge, the hinge rung having a flat portion which contacts the structure when the ladder is in a leaning position with the rear section adjacent to and in parallel with the front section and leaning against the structure with the flat portion of the hinge rung contacting the structure; and a top lock assembly disposed with the hinge rung and engaged with the first hinge and the second hinge, the top lock assembly unlocks and locks the first hinge and the second hinge from the locked state to the unlocked state and from the unlocked state to the locked state.

The top lock assembly may include a top actuator which is attached to the top lock assembly to move the top lock assembly between the locked state and the unlocked state when actuated.

The front section of the ladder may have a section lock actuator to move the front section lock between the locked state and the unlocked state when actuated. The rear section lock also has a section lock actuator to move the rear section lock between the locked state and the unlocked state when actuated.

The first hinge of the ladder may comprise: a front rail hinge portion which is fixedly attached to the first front rail and has a front slot; and a rear rail hinge portion fixedly attached to the first rear rail and pivotally attached to the front rail hinge portion to rotate relative to the front rail hinge portion, the rear rail hinge portion having a plurality of rear slots, each rear slot of the plurality of slots corresponding with a desired position of the first rear rail relative to the first front rail.

The top lock assembly and the front section lock of the ladder may each include a right rod and a left rod.

The right rod of the top lock assembly of the ladder may extend into one rear slot of the plurality of rear slots and the front slot of the first hinge, and the left rod of the top lock assembly extends into one rear slot of the plurality of rear slots in the front slot of the second hinge when the top lock assembly is in the locked state.

The right rod of the front section lock of the ladder may extend into a slot of the first base front rail and the first fly front rail, and the left rod of the front section lock extends into a slot of the second base front rail and the second fly front rail when the front section lock is in the locked state.

The top lock assembly of the ladder may include a top spring disposed in the hinge rung between the right rod and the left rod which biases the right rod into one slot of the plurality of slots of the first hinge and into the locked state by maintaining the right rod in the one slot of the first hinge, and which biases the left rod into one slot of the plurality of slots of the second hinge and into the locked state by maintaining the left rod in the one slot of the left hinge.

The front rail hinge portion of the ladder may comprise a front outer hinge plate and a front inner hinge plate in spaced relation and in parallel and in alignment with the front outer hinge plate; the front outer hinge plate and front inner hinge plate each having a head and a tail; the head of the front outer hinge plate and the head of the front inner hinge plate each having a front slot which align; the rear rail hinge portion comprises a rear outer hinge plate and a rear inner hinge plate in spaced relation and in parallel and alignment with the rear outer hinge plate; the rear outer hinge plate and the rear inner hinge plate each having a head and a tail; the head of the rear outer hinge plate and the head of the rear inner hinge plate each having a first rear slot, a second rear slot and a third rear slot so that when the first base front rail and the first base rear rail are locked in a leaning ladder position, where the first base rear rail is adjacent to and in parallel with the first base front rail, the right rod is disposed in the front slot of the front outer hinge plate and the front inner hinge plate and the first rear slot of the rear inner hinge plate in the rear outer hinge plate in the locked state; when the first base front rail and the first base rear rail are locked in a stepladder position, where the first base rear rail forms an acute angle with the first base front rail, the right rod is disposed in the second rear slot of the rear inner hinge plate and the rear outer hinge plate in the locked state; when the first base front rail and the first base rear rail are locked in a straight ladder position, where the first base rear rail forms a straight angle with the first base front rail, the right rod is disposed in the third rear slot of the rear inner hinge plate and the rear outer hinge plate in the locked state; the rear inner hinge plate and the rear outer plate disposed between the front inner hinge plate and the front outer hinge plate.

The tail of the front outer hinge plate and the tail of the front inner hinge plate of the ladder may attach to the first base front rail, and the head of the front outer edge plate and the head of the front inner hinge plate create a gap, the head of the rear inner hinge plate and the head of the rear outer hinge plate are disposed in the gap, the head of the front inner hinge plate and the front outer hinge plate and the rear inner hinge plate and the rear outer hinge plate each have a pivot hole which align, and including a pivot pin which extends through the pivot hole of all the heads, the rear and front inner and outer hinge plates able to rotate about the pivot pin.

The tail of the rear inner hinge plate and the tail of the rear outer hinge plate of the ladder may attach to the first fly rear rail.

The top actuator of the ladder may include a right lever attached to the right rod and a left lever attached to the left rod, when the top actuator is actuated, the right and left levers are moved together causing the right rod and the left rod to move inwards toward each other, causing the spring between them to compress, and causing the right rod and the left rod to move out of any slots in the first hinge and second hinge, respectively, so the top lock assembly are in the unlocked state, when the right and left levers are released, the spring causes the right and left rod to move back into the first and second hinges and place the first and second hinges in the locked state. The section locks and section actuator operate in the same way as the top lock assembly and the top actuator, except that instead of slots in the first and second hinges, the right rod and the left rod extend into or retract from slots in the rails.

The first rear slot and the front slot of the ladder may be in alignment when the first base front rail and the first base rear rail are in the leaning ladder position.

In the ladder, when the top actuator is actuated, the first and second hinges may be simultaneously changed between the lock state and the unlocked state.

In the ladder, when the front section actuator is actuated, the right rod and the left rod may be simultaneously changed between the lock state and the unlocked state.

The front section lock of the ladder may include a first J lock attached to the right rod and a second J lock attached to the left rod, the first J lock slides in and out of a slot in the first front base rail and the first front fly rail and the second J lock slides in and out of a slot in the second front base rail and the second front fly rail to place the front section lock in either the locked state or unlocked state.

The front section of the ladder may include a first pusher attached to the right rod, the right rod attached to the first J lock with the right rod disposed between the first pusher and the first J lock, and a second pusher attached to the left rod, the left rod attached to the second J lock with the left rod disposed between the second pusher and the second J lock, there is a first J spring positioned about the right rod and a second J spring positioned about the left rod.

The section lock actuator of the ladder may include a right lever attached to the first pusher and a left lever attached to the second pusher, when the section lock actuator is actuated, the right and left levers are moved together causing the right rod and the left rod to move outwards away from each other, causing the first and second J springs to compress, and causing the first J lock and the second J lock to move out of any slots in the first front base and fly rails and the second front base and fly rails, respectively, so the section lock assembly is in the unlocked state, when the right and left levers are released, the first and second J springs cause the first and second J locks to move back into the first front base and fly rails and the second front base and fly rails and place the section lock actuator in the locked state.

The front section lock of the ladder may be disposed in one a rung, a hinge, a top actuator, a top lock assembly, a front section lock, and/or a section lock actuator.

In some aspects, a method for using a multi-position ladder comprises the steps of: actuating a section lock actuator attached to a front section lock of the ladder causing a first front fly section and first front base section to move between a locked state and an unlocked state; moving the first front fly section relative to the first front base section; and locking the first front fly section to the first front section in the desired ladder mode.

In other aspects, a method for using a multi-position ladder comprises the steps of: actuating a top lock actuator attached to a top locking assembly in a hinge rung of the ladder causing a first hinge and a second hinge of the ladder attached to the hinge rung to move between a locked state and an unlocked state; moving a rear section relative to the front section about the first and second hinges when the first and second hinges are in the unlocked state to either a leaning ladder mode, a stepladder mode, a stairway ladder mode, and a straight ladder mode, the front and rear sections attached to the first and second hinges; and locking the rear section relative to the front section in the desired ladder mode.

In some aspects, a method for producing a multi-position ladder comprises the steps of: attaching a hinge rung to a first hinge of the ladder, the hinge rung having a top lock assembly with a top actuator to a rung on a front section of the ladder, the actuator causes a first hinge and a second hinge of the ladder to move between a locked state and an unlocked state; and attaching the hinge rung to a second hinge of the ladder.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1. A rail assembly comprising:
a first rail including a first opening extending therethrough;
a second rail opposite the first rail, the second rail including a second opening extending therethrough; and
a lock assembly disposed between the first rail and the second rail to selectively engage the first opening and the second opening, the lock assembly including:
a first rod having a proximal end portion adjacent to the first rail and a distal end portion opposite the proximal end portion;
a second rod having a proximal end portion adjacent to the second rail and a distal end portion opposite the proximal end portion;
a first pusher having a first flange portion that engages the first rod, a first lever extending from an outer surface of the first pusher; and
a second pusher having a second flange portion that engages the second rod, a second lever extending from an outer surface of the second pusher to create a pinch grasp portion with the first lever;
the lock assembly having a locked position in which one or more of the proximal end portion of the first rod engages the first opening and the proximal end portion of the second rod engages the second opening, and an unlocked position in which one or more of the proximal end portion of the first rod disengages the first opening and the proximal end portion of the second rod disengages the second opening.

2. The rail assembly of claim 1, wherein the first pusher further includes a first leg portion extending from the first flange portion opposite the first rod, and wherein the second pusher further includes a second leg portion extending from the second flange portion opposite the second rod, wherein the first lever is disposed at a distal end of the first leg portion and wherein the second lever is disposed at a distal end of the second leg portion, and wherein first leg portion and the second leg portion are lapped such that the first lever is positioned closer to the second rail than the second lever and the second lever is positioned closer to the first rail than the first lever.

3. The rail assembly of claim 2, wherein the first leg portion and first flange portion form an L-shape, and wherein the second leg portion and the second flange portion form an L-shape.

4. The rail assembly of claim 1, wherein the first pusher slidingly engages the second pusher.

5. The rail assembly of claim 1, wherein the first lever and the second lever of the pinch grasp portion are farther apart in the locked position than in the unlocked position.

6. The rail assembly of claim 1, wherein operating the pinch grasp portion to move the first lever towards the second lever moves the lock assembly from the locked position to the unlocked position.

7. The rail assembly of claim 6, wherein moving the first lever toward the second lever causes the first flange portion of the first pusher to move the proximal end portion of the first rod away from the first rail such that the proximal end portion of the first rod disengages from the first opening, and causes the second flange portion of the second pusher to move the proximal end portion of the second rod away from the second rail such that the proximal end portion of the second rod disengages the second opening.

8. The rail assembly of claim 1, wherein releasing the pinch grasp portion to move the first lever away from the second lever moves the lock assembly from the unlocked position to the locked position.

9. The rail assembly of claim 8, wherein moving the first lever away from the second lever causes the first flange portion to move the proximal end portion of the first rod towards the first rail such that the proximal end portion of the first rod engages with the first opening, and causes the second flange portion to move the proximal end portion of the second rod toward the second rail such that the proximal end portion of the second rod engages the second opening.

10. The rail assembly of claim 1, wherein the proximal end portion of the first rod includes a first j-lock and the proximal end portion of the second rod includes a second j-lock, and wherein moving the first lever away from the second lever places the pinch grasp portion in the locked position.

11. The rail assembly of claim 10, wherein moving the first lever away from the second lever further causes the first pusher to push a portion of the first j-lock into the first opening and causes the second pusher to push a portion of the second j-lock into the second opening.

12. The rail assembly of claim 1, wherein moving the first lever away from the second lever moves the first rod towards the second rod.

13. The rail assembly of claim 1, wherein the first rod is a portion of a first j-lock assembly, the first j-lock assembly including a first spring disposed between the first flange portion of the first pusher and the first rail; and wherein the second rod is a portion of a second j-lock assembly, the second j-lock assembly including a second spring disposed between the second flange portion of the second pusher and the second rail.

14. The rail assembly of claim 13, wherein, in the unlocked position, the first spring is further compressed between the first rail and the first flange portion and the second spring is further compressed between the second rail and the second flange portion.

15. The rail assembly of claim 14, wherein the first spring and the second spring bias the first pusher and the second pusher towards each other to place the lock assembly in the locked position.

16. A rail assembly comprising:
a first rail including a first opening extending therethrough;
a second rail opposite the first rail, the second rail including a second opening extending therethrough; and
a lock assembly disposed between the first rail and the second rail to selectively engage the first opening and the second opening, the lock assembly including:
a first rod having a proximal end portion adjacent to the first rail and a distal end portion opposite the proximal end portion, the distal end portion of the first rod coupled to a first lever; and
a second rod having a proximal end portion adjacent to the second rail and a distal end portion opposite the proximal end portion, the distal end portion of the second rod coupled to a second lever, the second lever creating a pinch grasp portion with the first lever;
the lock assembly having a locked position in which one or more of the proximal end portion of the first rod engages the first opening and the proximal end portion of the second rod engages the second opening, and an unlocked position in which one or more of the proximal end portion of the first rod disengages the first opening and the proximal end portion of the second rod disengages the second opening.

17. The rail assembly of claim 16, wherein the first lever is disposed at a distal end portion of the first rod and wherein the second lever is disposed at a distal end portion of the second rod.

18. The rail assembly of claim 16, wherein the lock assembly further includes a spring disposed between the distal end portion of the first rod and the distal end portion of the second rod, the spring biasing the first rod and the second rod away from each other.

19. The rail assembly of claim 18, wherein moving the first lever towards the second lever compresses the spring.

20. The rail assembly of claim 16, wherein operating the pinch grasp portion to move the first lever towards the second lever moves the lock assembly from the locked position to the unlocked position.

21. The rail assembly of claim 20, wherein moving the first lever towards the second lever moves first rod away from the first rail such that the proximal end portion of the first rod disengages from the first opening, and moves the second rod away from the second rail such that the proximal end portion of the second rod disengages the second opening.

22. The rail assembly of claim 16, wherein releasing the pinch grasp portion to move the first lever away from the second lever moves the lock assembly from the unlocked position to the locked position.

23. The rail assembly of claim 16, wherein moving the first lever away from the second lever moves the first rod toward the first rail such that the proximal end portion of the first rod engages the first opening and moves the second rod toward the second rail such that the proximal end portion of the second rod engages the second opening.

24.-32. (canceled)

33. A ladder comprising:
a first section including a first left rail and a first right rail opposite the first left rail; and
a second section including a second left rail and a second right rail opposite the second left rail, the second section having a lock assembly disposed between the second left rail and the second right rail, the lock assembly including:
a right rod having a proximal end portion adjacent to the second right rail and a distal end portion opposite the proximal end portion, the distal end portion of the right rod coupled to a right lever; and
a left rod having a proximal end portion adjacent to the second left rail and a distal end portion opposite the proximal end portion, the distal end portion of the left rod coupled to a left lever, the right lever creating a pinch grasp portion with the left lever;
the lock assembly having a locked position in which one or more of the proximal end portion of the right rod engages the first right rail and the second right rail and the proximal end portion of the left rod engages first left rail and the second left rail, and an unlocked position in which one or more of the proximal end portion of the right rod disengages the first right rail and the second right rail and the proximal end portion of the left rod disengages the first left rail and the second left rail.

34. The ladder of claim 33, wherein operating the pinch grasp portion to move the right lever toward the left lever moves the lock assembly from the locked position to the unlocked position.

35. The ladder of claim 33, wherein the proximal end portion of the right rod is a straight segment, and wherein the proximal end portion of the left rod is a straight segment.

36.-42. (canceled)
